(19) United States
(12) Patent Application Publication
(10) Pub. No.: US 2014/0101062 A1
(43) Pub. Date: Apr. 10, 2014

(54) METHOD, SYSTEM AND COMPUTER PROGRAM PRODUCT FOR AUDITING, COMPLIANCE, MONITORING AND COMPLIANCE MANAGEMENT

(71) Applicant: COLA, Columbia, MD (US)

(72) Inventors: Douglas A. BEIGEL, Columbia, MD (US); Kirk COUSER, Columbia, MD (US)

(73) Assignee: COLA, Columbia, MD (US)

(21) Appl. No.: 14/012,935

(22) Filed: Aug. 28, 2013

Related U.S. Application Data
(60) Provisional application No. 61/694,053, filed on Aug. 28, 2012.

(51) Int. Cl. G06Q 30/00

(52) U.S. Cl. CPC G06Q 30/018
USPC 705/317

(57) ABSTRACT

Compliance auditing and management is provided by defining business or enterprise assets, comprising receiving, from the business or enterprise variables that meet business needs of the business or enterprise as a user. Users, locations and audit templates are added. Questions to be provided to the user are entered and compliance criteria used in answering the questions and associating the compliance criteria with the questions are added. Compliance activity information from the user is received and the compliance activity information from the user to the questions is applied. Compliance activity for the user to generate a database of deployed compliance activities is scheduled and the database of deployed compliance activities is used to conduct compliance activity. The database of deployed compliance activities or the conducted compliance activity is used to generate files and incidents. The database of deployed compliance activities is used to generate compliance activity reporting.

### RELATED APPLICATION(S)

The present Patent Application claims priority to Provisional Patent Application No. 61/694,053 filed Aug. 28, 2012, which is assigned to the assignee hereof and filed by the inventors hereof and which is incorporated by reference herein.

### BACKGROUND

1. Field

The present disclosure relates to audit and compliance techniques and software.

2. Background

Compliance audits are required for regulated procedures such as, by way of non-limiting example, medical laboratories used for performing medical tests.

A typical compliance process is often heavily paper-based, and involves collection of documents, creating lag time in entering data, greater opportunities for inaccuracies and errors. Inefficiencies exist because the lag time in reporting can affect managerial decisions, time spent on site for audit/surveys can be inefficient, and communication can be fractured amongst levels of management and employees.

There has been a significant increase in the need for compliance and oversight across a broad range of industries, many of which did not have any of those requirements placed upon them before. The need to develop a data-driven, real time compliance process is higher than ever. Currently, there are few compliance management programs or techniques that allow for quick deployment and simple customization and yet still provide real time

### BRIEF DESCRIPTION OF THE DRAWINGS

FIG. 1 is a flow diagram showing the operation of the program.

FIG. 2 is a diagram showing the relationship between the compliance criteria and questions asked of the user.

FIG. 3 is a diagram showing the relationship between the questions asked of the user with comments and scoring.

FIG. 4 is a diagram showing the use of the generated files, comments or incident reports and deployed compliance activities.

FIG. 5 is a diagram showing the implementation of audit conducting and reporting tools.

The remaining figures depict deployment of the program for implementation in performing audits.

### DETAILED DESCRIPTION

### Overview

The disclosed technology, referred to as “CompWalk” is a comprehensive Auditing, Compliance, Monitoring, and (On Demand) Facility Auditing & Compliance Management System. It is designed to be accessible and user-friendly, a highly accessible compliance software program. The present subject matter utilizes easy to configure and web-based and mobile application tools; multiple feature modules allow for integrated communication in real time; create an manage multiple audit/survey deployments; real time Executive dashboard reporting and the ability to create ad hoc reports.

The disclosed technology implements an Audit and Compliance Walkthrough management system that delivers mobile-friendly, web-based software tools and applications to connect management and personnel in the field with unparalleled ease. With the disclosed technology's on-demand auditing and compliance workflow, you can customize user permissions, survey content and reporting—system-wide—in a few simple clicks. Since The disclosed technology implements delivery through the Software as a Service (SaaS) model, (it works via the Internet), organizations can access the power of a much larger compliance system while maximizing cost-efficiencies by avoiding the expense of software upgrades, support and training typically associated with legacy systems (that can require complex installation procedures).

### Real-Time, Enterprise-Friendly Audit Management and Data Collection

Scalable to meet each individual company's size and growth, the disclosed technology provides centralized access to compliance and audit information in real time making it an invaluable management tool for organizations looking to be more agile in today's ever changing marketplace.

### Compliance Management with Less Paper and More Power

With the disclosed technology, organizations are able to automate manual audit processes and manage people, procedure and technology seamlessly. The disclosed technology's mobile flexibility makes paperless compliance inspections more efficient and simplifies field data collection during follow-ups to regulatory inspections and incident investigations. In addition, organizations can also leverage the disclosed technology's compliance management and communication framework as a vehicle for new and ongoing personnel training, new policy and procedure implementation.

Real-time Data Submission & Reporting

Flexible Scoring Metrics

Web-based & Mobile Audit Tools

Unlimited Audit/Survey Creation

Conduct more audits, more accurately

Ability to Use for Training

More Control Over the Entire Process

More Integrated Communication within the Organization

The development of the disclosed technology provides improvements in the laboratory accreditation arena and applies proprietary technologies, knowledge and experience to respond to market demands for a more streamlined approach to audit and compliance management programs across a wide range of industries.

### Quality, Compliance & Audit Management Features & Benefits

What separates the disclosed technology's audit and compliance software from other web-based audit software or techniques is its advanced, customizable, on-demand software implementation for all types of compliance needs. Since the disclosed technology implements delivery through the SaaS model, organizations can leverage the power of a much larger compliance system at a fraction of the cost and access regular upgrades, community-based support and training while avoiding the pitfalls and expense of legacy-based systems.

### Flexibility, Mobility & More Capabilities any Compliance Program

What separates the disclosed technology's audit and compliance software from other web-based audit software and techniques is its advanced, customizable, on-demand program for all types of compliance needs. Since the disclosed technology implements delivery through the SaaS model, organizations can leverage the power of a much larger compliance system at a fraction of the cost and access regular upgrades, community-based support and training while avoiding the pitfalls and expense of legacy-based systems.

The disclosed technology provides pre-defined users with the ability to dynamically create their own surveys, questions and scoring criteria, as well as to track versions of surveys and questions so that a full history is always available for reference. This degree of control and flexibility increases efficiency, quality and accuracy across the organization's audit program.

There are 3 ways through which users can connect with the software:

STANDARD USER TOOLS: Web Portal and/or Mobile Application

FIELD AUDIT TOOLS: Web-Based Survey Application, A Mobile Survey Application and a Netbook Survey Application

EXECUTIVE MANAGEMENT TOOLS: Web-Based Dashboard and Reporting Applications

### Manage Quality with Robust Monitoring & Reporting

The disclosed technology provides executives and management with the real-time dashboard monitoring and reporting capabilities across all locations and personnel. The disclosed technology makes it easier to obtain a current and accurate snapshot of how the overall organization is performing against established policies and guidelines set by the management team. Data can be filtered and analyzed through an endless number of reporting capabilities such as how one brand is performing against another or how the west coast compares with other regions in the country. It is all available in real time for the user's team to view, analyze and act upon.

Management can also use the system as a communications framework for delivering new policies and procedures into the field in real time. New descriptions of policies and procedures can be quickly and easily added to the system with instant alerts sent out to relevant users. It is further contemplated that these alerts will be able to be delivered in multiple formats—as written text, as visual imagery and/or video—to assist employees in better understanding new directions for implementation. Field auditors will also be able to upload images and documents to show management actual tactical examples of how decisions are being interpreted, both properly and improperly.

### Increase Auditors' On-Site Productivity & Efficiency

Enabling field representatives to perform more audits, more accurately, is a key benefit to the system. From preparation and audit walkthrough to compliance walkthrough and final review, the disclosed technology enables auditors to increase productivity, save time, reduce paper, avoid penalties, streamline workflow, reduce data entry errors and improve communication. Auditors can now see their schedules ahead of time, access and/or download relevant information for pending site visits (such as personnel information, special competencies, historical performances, outstanding issues/citations, previous auditor notations, etc.) allowing for the actual time on site to be as minimal and efficient as possible.

Accessible from three portals—through the web, through a mobile app or via a netbook, notebook or laptop, among other portable or non-portable devices—the disclosed technology's survey tool provides auditors with an easy-to-use, paperless, automated interface from which to conduct audit and compliance walkthroughs. The survey tool also gives the organization's management control over customizing survey questions and content, ratings and other settings—as well as the ability to make changes quickly and easily, system-wide.

Users may choose to access the disclosed technology via laptops, online or offline. When working offline, the application will sync data with the database when an Internet connection is re-established. This ability to operate the disclosed technology locally offers additional functionality and flexibility when an on-site Internet connection is not available.

In one configuration, the disclosed technology is implanted over the internet using a web browser. All that is required is an Internet connection and a browser such as Internet Explorer, Mozilla Firefox, Opera, Chrome, etc., to access the web-based implementation of the disclosed technology.

The disclosed technology can accommodate an unlimited number of users, and user roles can be customized, defined, updated, added, deleted and edited as needed. Permissions can also be customized per role, to define or limit access to specified content. Users can also be assigned multiple roles.

The disclosed technology provides pre-defined users with the ability to dynamically create an unlimited number of their own surveys, questions and scoring criteria, as well as to track versions of surveys and questions so that a full history is always available for reference. This degree of control and flexibility increases efficiency and accuracy across the organization's audit program.

The disclosed technology enables users—both executive and general users—to customize reports based on their organizations' needs. Reports can be created based on anything from survey results to auditor efficiency and performance to location activity or any other data management wishes to extract. Reports can be exported to Excel (.csv) and PDF.

The user experience can be branded and customized to reflect the user organization's logo or color palette. The disclosed technology is scalable so it is accessible and ready to meet each individual company's size and growth.

### Compliance Management Scenario

The disclosed technology is flexible, and may be adapted to incorporate branded login and messaging

Easy to use web-based and mobile application tools make the system a real time communications platform.

The disclosed technology's Reporting Dashboards give Executives a clear view of what is happening in the field so they can monitor their compliance and quality assurance issues more effectively.

### Executive Dashboard

Features of the Executive Dashboard include real-time reporting.

Installation/Employee Dashboard enables Immediate Compliance Reinforcement

Document manager

Administrative manager's tools include

“Locations manager”

“Add a location”

“User manager”

“Add a user screen”

“Add a role screen”

“Criteria manager”

“Question manager”

“Add a question”

“Manage question scoring”

“Audit manager”

“Create a new audit”

“Create an audit—add sections”

“Create an audit—add questions”

“Conduct a quick audit”

“Take a self-assessment”

“Individual audit question”

The disclosed technology allows you to schedule an audit/tour

The disclosed technology provides a help desk to aid in answering questions.

The disclosed technology further offers Mobile Compliance, for example through a Real-time Mobile Audit Application for a portable mobile device.

In addition, computer (desktop, laptop, netbook, tablet, etc) applications are available.

Architecture Overview—Solid SaaS Architecture with adaptability allows the disclosed technology to be utilized by and work for a variety of industries and applications

### Implementation

There has been a significant increase in the need for compliance and oversight across a broad range of industries, many of which did not have any of those requirements placed upon them before. The need to develop a data-driven, real time compliance process is higher than ever. Currently, there are few compliance management techniques that allow for quick deployment and simple customization and yet still provide real time data delivery across multiple devices. The majority of the marketplace is niche to an industry and many are still not fully real time or providing mobile compliant tools.

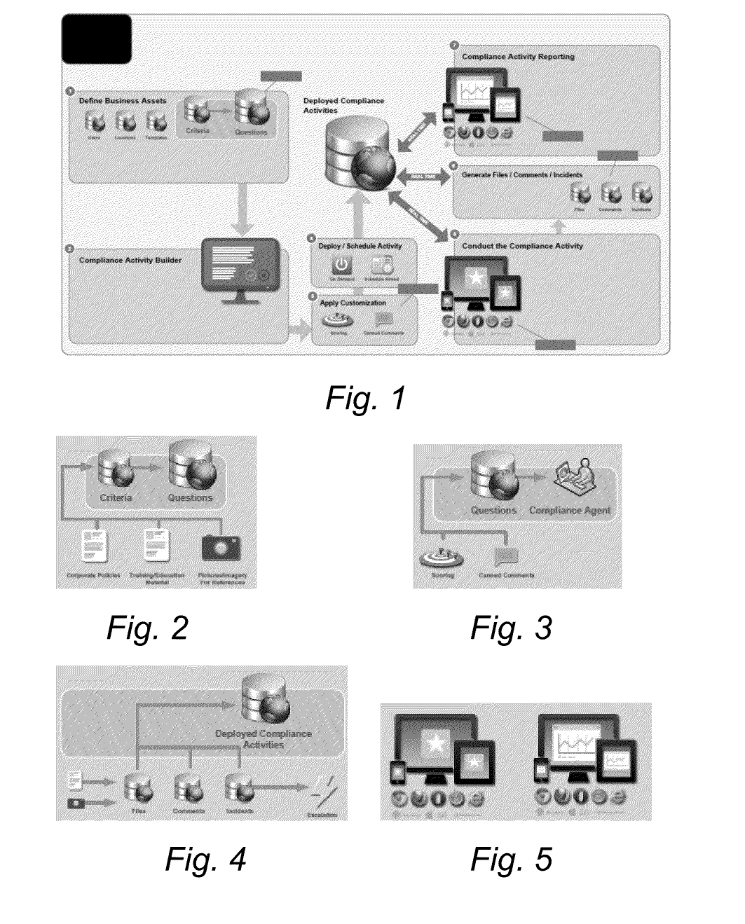

FIG. 1 is a diagram showing an overview of the disclosed technique and how it helps to solve the above problem. There is a progression through which the platform is initially set-up for a business/organization and then once established, the ability to generate the necessary compliance tools and deploy activities becomes very easy and quick to deploy. Its uniqueness revolves around its flexibility and adaptability to almost any compliance situation or requirement.

In step 111, business or enterprise assets are defined. Owner/Administrators of the system can set-up the necessary variables that meet their business needs. Users, locations, and pre-canned audit templates, are added into the system for ready use when it comes time to build the necessary compliance tools. Questions can be entered into the system and then “criteria” can also be added and then “connected” to a question to support a variety of business needs.

In step 112, compliance activity is built by using the assets of the system to “build” their compliance activity, or establish a compliance activity plan. Owner/Administrators/Authorized Users of the system can now use the assets of the system to establish the compliance activity plan to include their compliance activity (i.e. survey, audit, checklist, etc.) and then either assign and deploy it immediately to be given or schedule it for a pre-determined time and place. Either way, the person conducting the activity gets immediately notified and then has the ability review all aspects of the activity. They can review the questions, scoring, criteria associated, etc. They can also request modifications back to the compliance author or make them themselves depending on permissions.

In step 113, customization is applied. The customization can optionally include an application of question scoring, in which questions can be given unique scoring ranges based on business needs and adjusted from one activity to another when necessary. In addition to customization, canned comments may be incorporated, which, by way of non-limiting example, be generated in accordance with the data previously received in steps 111 and 112, or from information obtained from previous audits.

In step 114, schedule activity is deployed or scheduled. This can, by way of non-limiting examples, be scheduled ahead or performed on demand. This results in deployed compliance activities 120. The deployed compliance activities can be implementations of conducting compliance activities (step 131), generating files or incidents (step 132) or compliance activity reporting (step 133). These procedures 131-133 can be performed in real time as real time implementations of the compliance activities.

In step 131, compliance activities are conducted. The designated compliance users (e.g. surveyor, auditor, quality manager, etc.) of the system can now conduct their compliance activity using any of the tools that work best for the given situation. Use of handheld mobile devices, tablets or laptop/desktop stations can work as well. The compliance agent can go through, answer all items, review connect support materials if needed. They can also attach files related to a question or activity, they could take pictures and attach as well specific to a question and/or activity overall. In addition, the compliance agent can initiate an “incident” that is associated with a specific question or the activity overall. The incident then allows for predetermined paths of escalation within the business.

In step 132 generating files or incidents are generated. This can also be the outcome of the compliance activities performed in step 131. Files, comments and/or incidents that a compliance agent generates, become “specific” to that question result and/or compliance activity. All participants in the process can have access to materials related to the compliance activity and issues related to the compliance activity. This generates files 141, comments 142 or incident reports 143.

In step 133, reporting of compliance activity is performed. Once compliance activities are deployed, conducted and recorded, the information becomes immediately available for reporting within the platform. The information provided is viewable across a multitude of both mobile and desktop devices across multiple operating systems. Therefore access to critical quality control, compliance and management information is available nearly instantaneously.

FIGS. 2-5 are diagrams depicting aspects of the disclosed technique of FIG. 1. These features, when combined, are very effective in providing for quick and easy set-up and deployment for compliance required situations. As a result, without a great deal of customization and large expense, business organizations can utilize these unique components to establish a real-time compliance management system quickly and affordably.

FIG. 2 is a diagram showing the relationship between the compliance criteria and questions asked of the user. Any question added to the system can then have criteria attached to it so that when a compliance agent is conducting an activity, or any end user is reviewing the activity results, they can connect to that criteria.

Criteria are added into the system by an Administrator and can be made up of anything that fits the need of the business. It could be a set of corporate guidelines that is broken down into specific parts for access. Criteria might be support or training related material describing the proper procedure or process steps for a particular subject. The criteria might also take the form of pictures or images showing how something should be displayed or set-up.

The ability to connect criteria to questions which then are transferred through to the final compliance activity and results makes the platform an invaluable tool for reinforcing business policies and procedures, training and education applications within the business enterprise and or communicating and distributing valuable updates for a variety of business applications.

This flexibility gives the software the opportunity to be utilized in a broad range of industries and roles and not be considered stuck in a niche market.

FIG. 3 is a diagram showing the relationship between the questions asked of the user with comments and scoring. The software's Activity scoring relies on a per-question scoring model. This model provides the flexibility to configure a system wide minimum, maximum and default value for a compliant, non-compliant and not applicable answer values. From the defaults, when creating or editing Questions, the admin level user is able to assign scoring values between the previously mentioned ranges. Upon completing an Activity, the score total is calculated per question based on the score values and the answer the Compliance Agent selected and subsequently stored in the database. Based on this model, a completed Activity's score could be negative or positive depending how the Compliance Agent answered the questions and how an admin level user weighted each of the questions three answer types (compliant, non-compliant and not applicable).

Additionally, text at the Activity level can be associated with a given score value, based on a scoring range. This text is configurable by an admin level user while building the Activity. Upon completion, if the Activity's score falls in one of the user defined ranges, the text will show on the Activity report if the user's Activity Template contains the merge field for the Scoring Range.

Comments can be preloaded for any question or set of questions within an Activity. This allows for frequent comment responses to easily be added by Compliance Agents where appropriate.

FIG. 4 is a diagram showing the use of the generated files 141, comments 142 or incident reports 143 and deployed compliance activities 120. During the compliance activity, the compliance agent who is conducting that activity can at any point during recording an answer for a question, attach a file, add a comment, or initiate an “incident”; all of which then becomes specifically tied to that question and/or compliance activity.

During the compliance activity, the compliance agent who is conducting that activity can at any point during recording an answer for a question, attach a file, add a comment, or initiate an “incident”; all of which then becomes specifically tied to that question and/or compliance activity. Items such as forms, documents, or even photos can be attached as reference material to the question. The items then become stored in the File Manager Module for future reference/look-up if need be. Comments can be applied to the question response by the compliance agent either by typing in a free form comment and/or selecting from pre-canned comment options if they have been added to the question and/or compliance activity form.

If the compliance agent sees an issue that they feel requires immediate and/or closer attention, they can initiate an incident specific to the question and/or compliance activity they are conducting. The incident is a description of the problem with all associated fields and material and is submitted into the Incident Manager Module which then follows a path of escalation. The path of escalation is established by a Compliance Administrator and those paths can be customized for specific types of issues. Alerts and notifications are sent out based on the setting that have been put in place. The incident persists within the system until it becomes resolved.

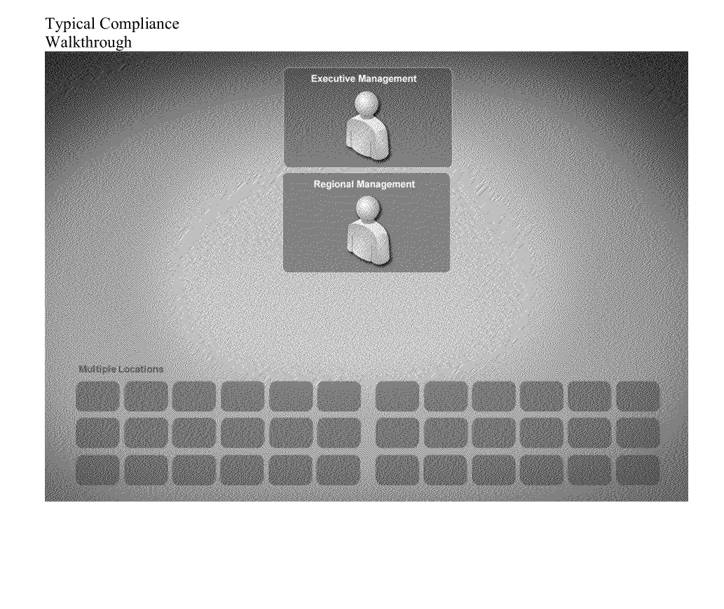

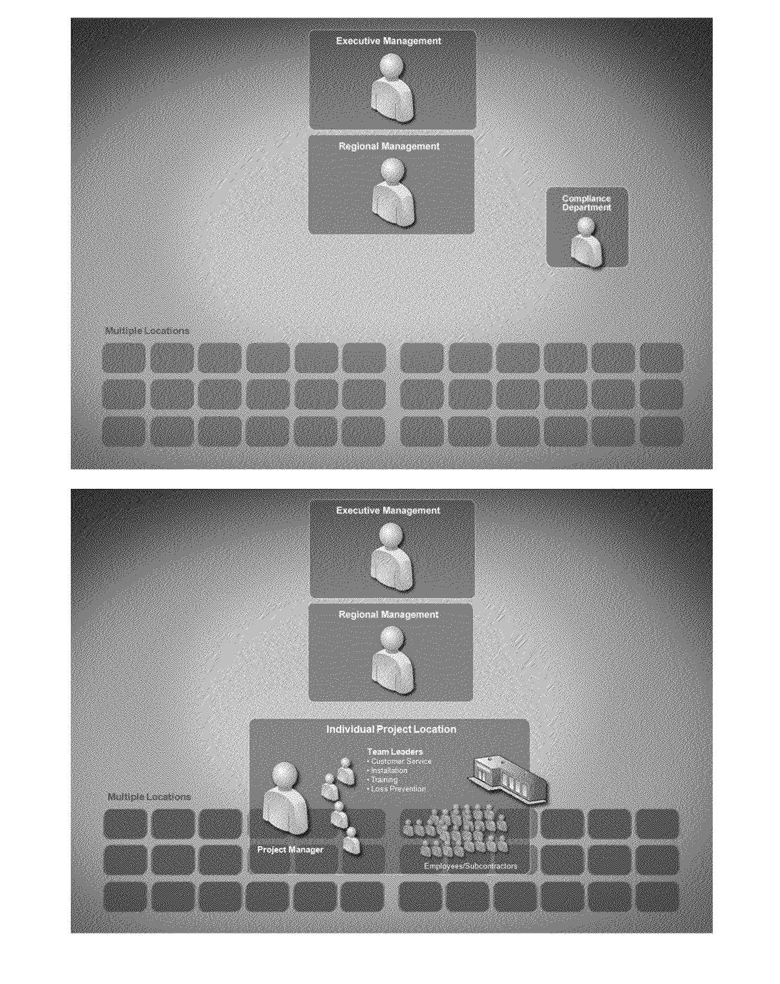

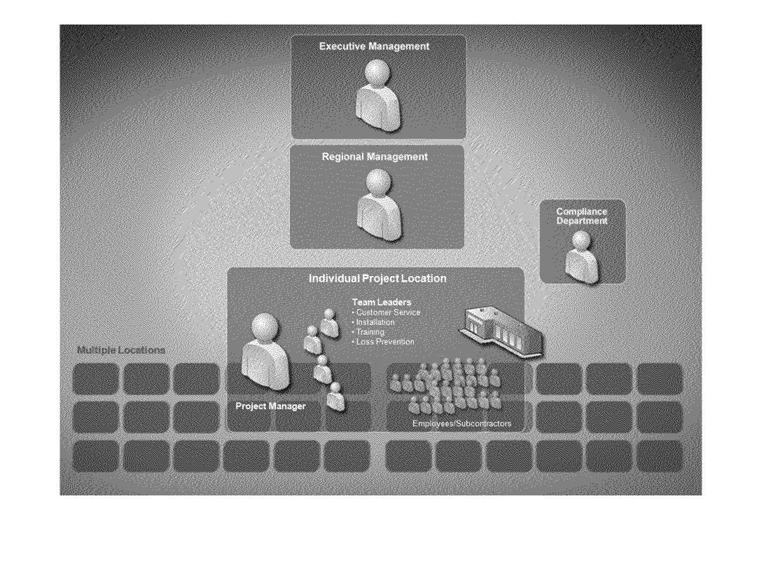

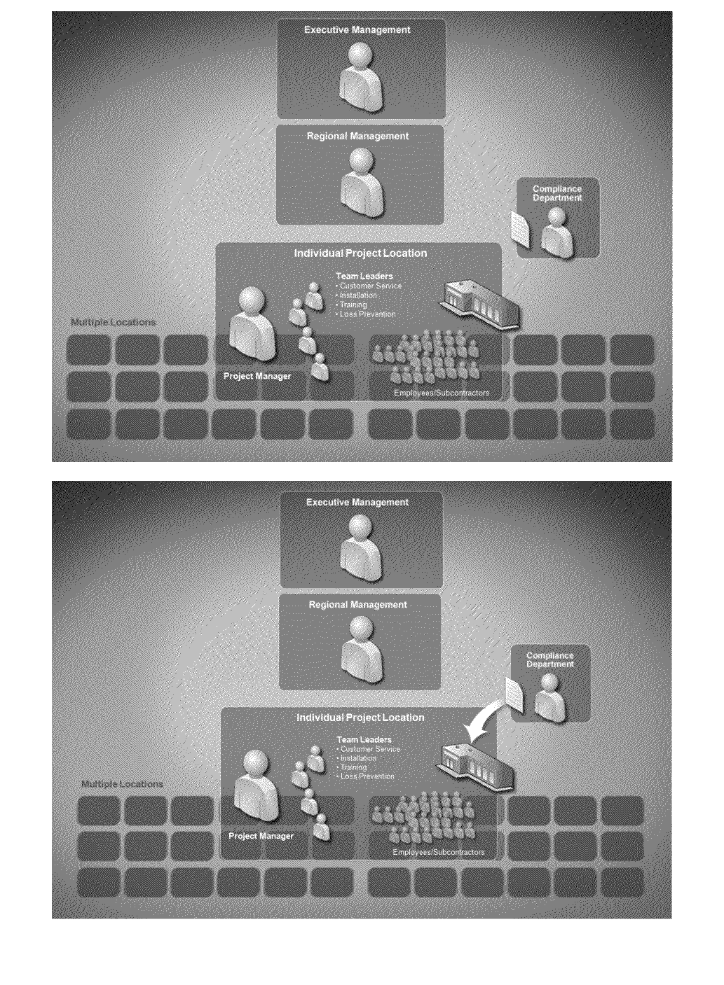

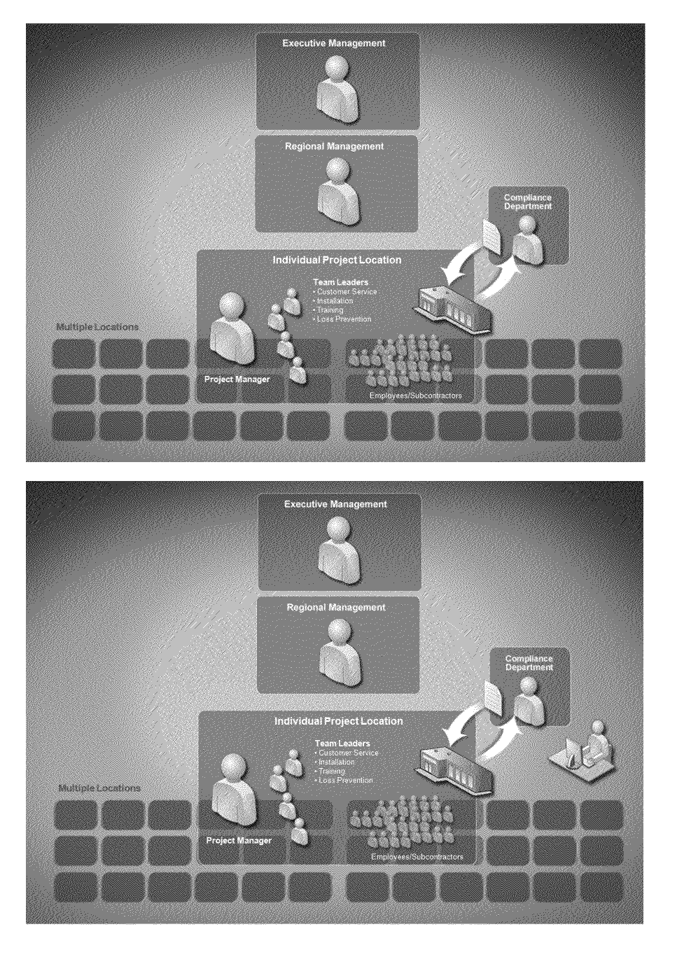

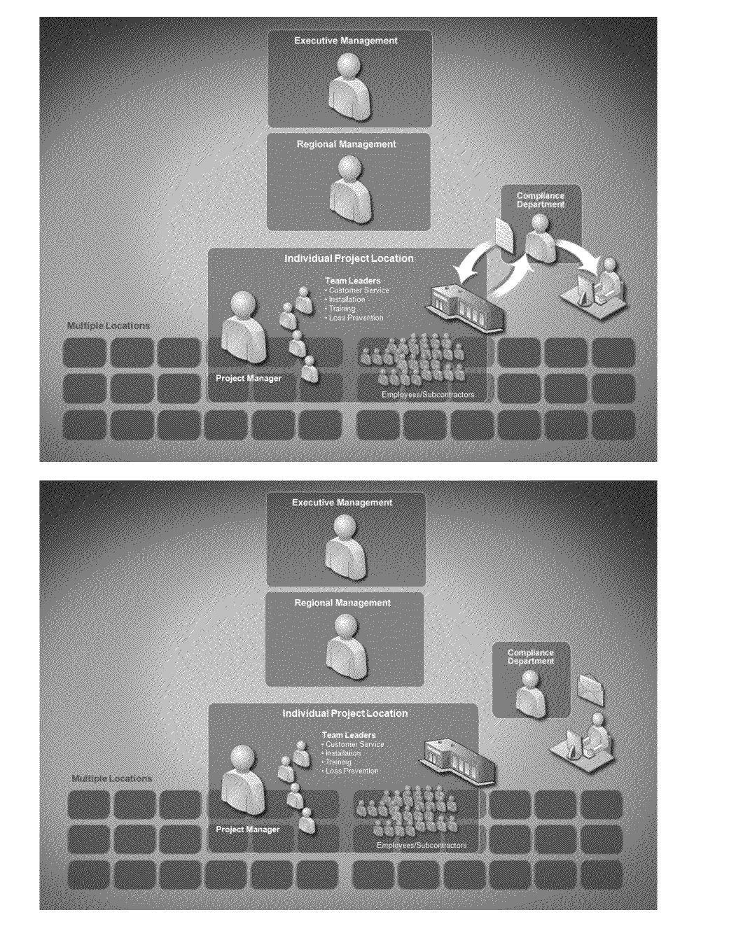

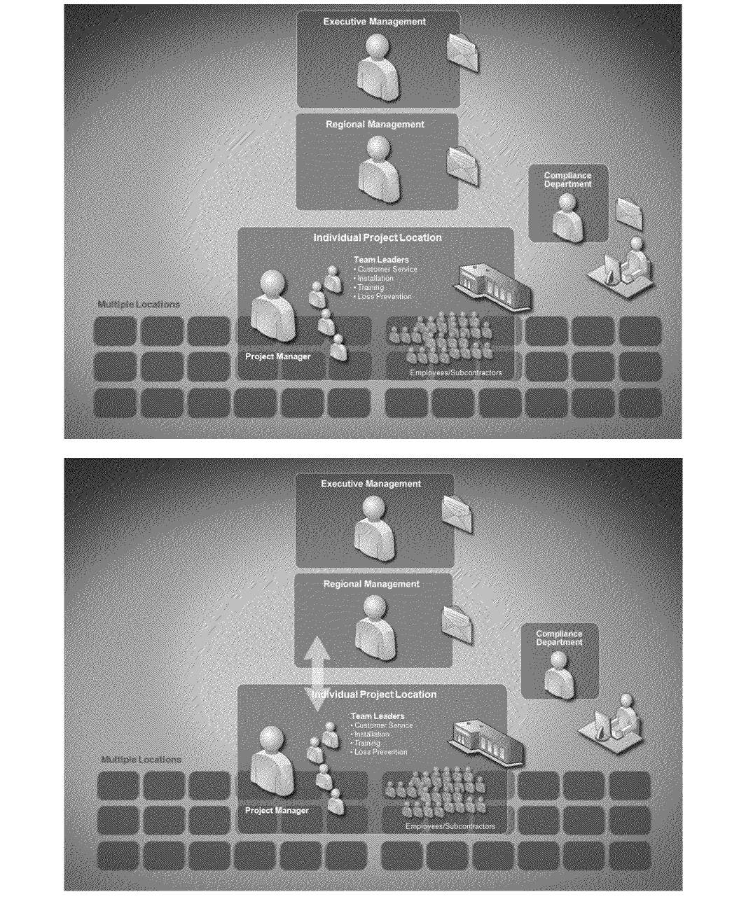

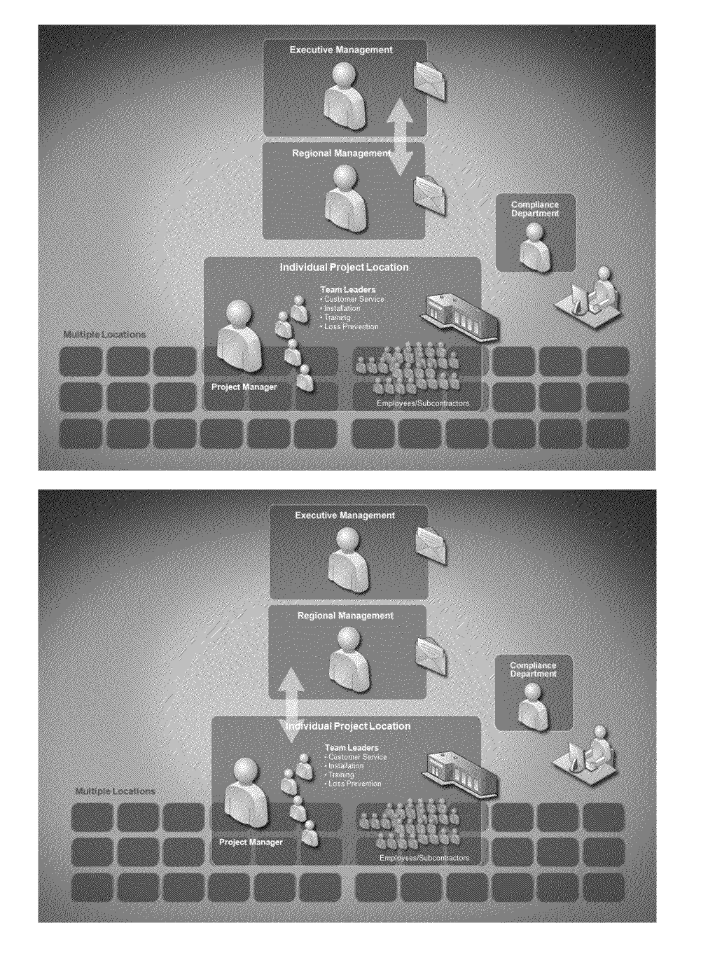

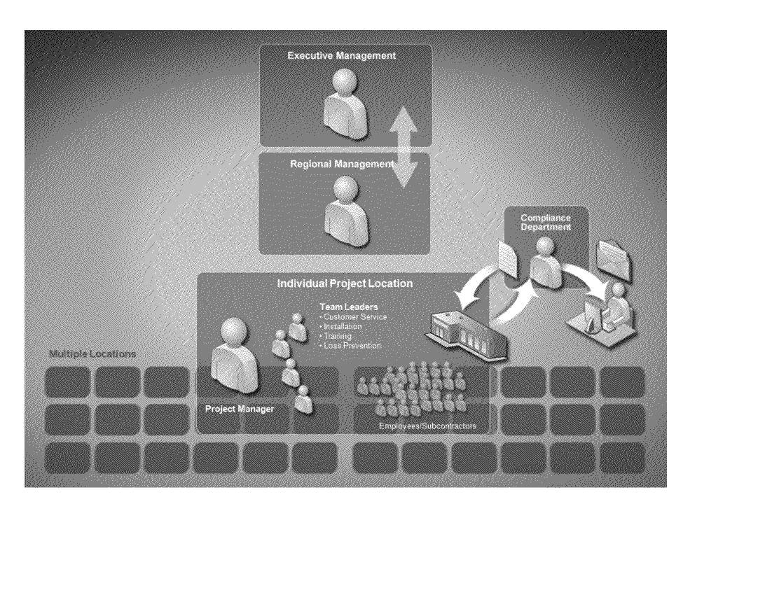

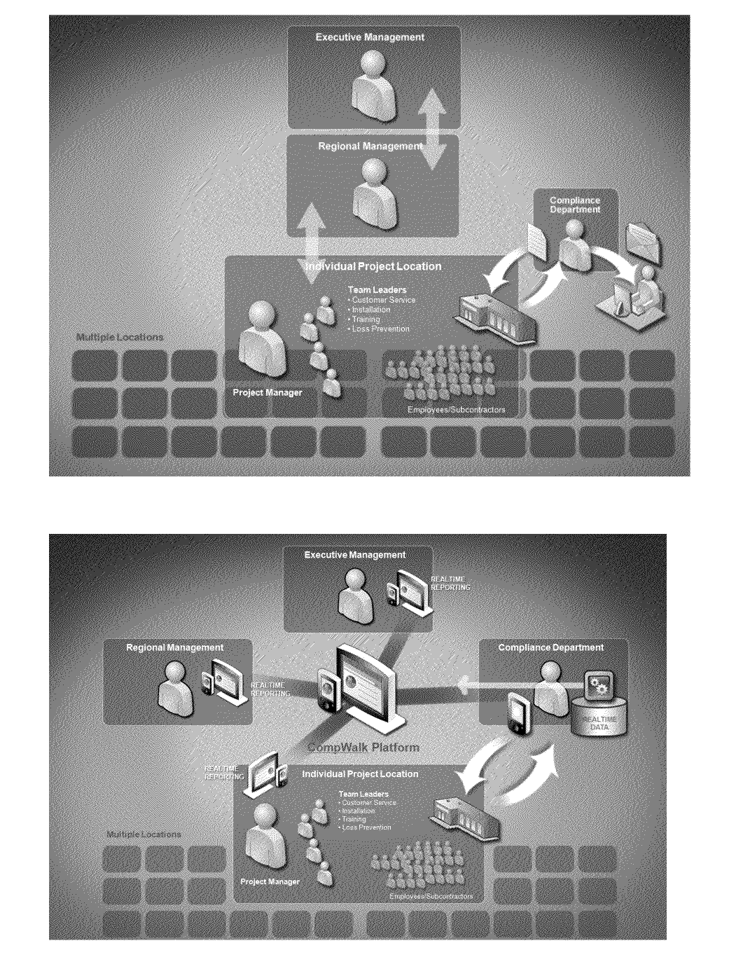

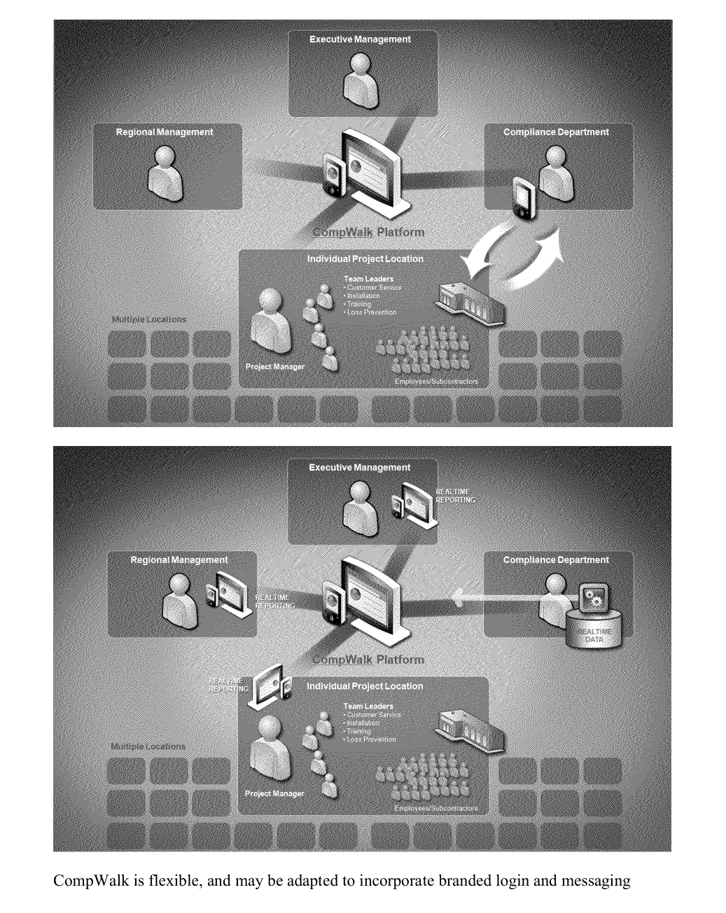

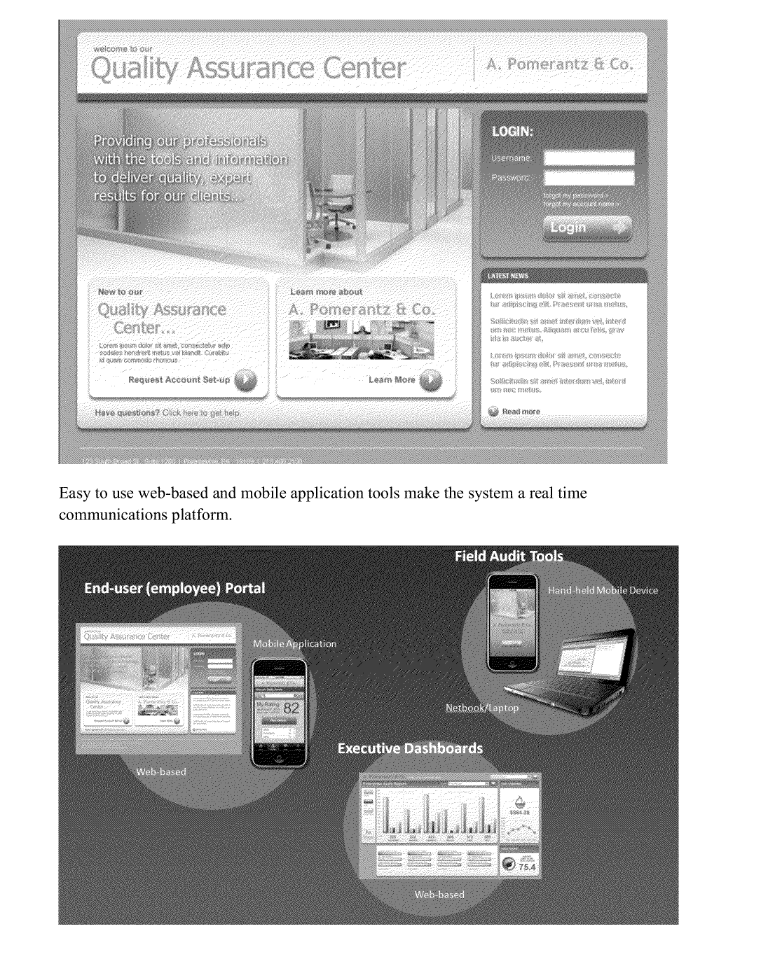

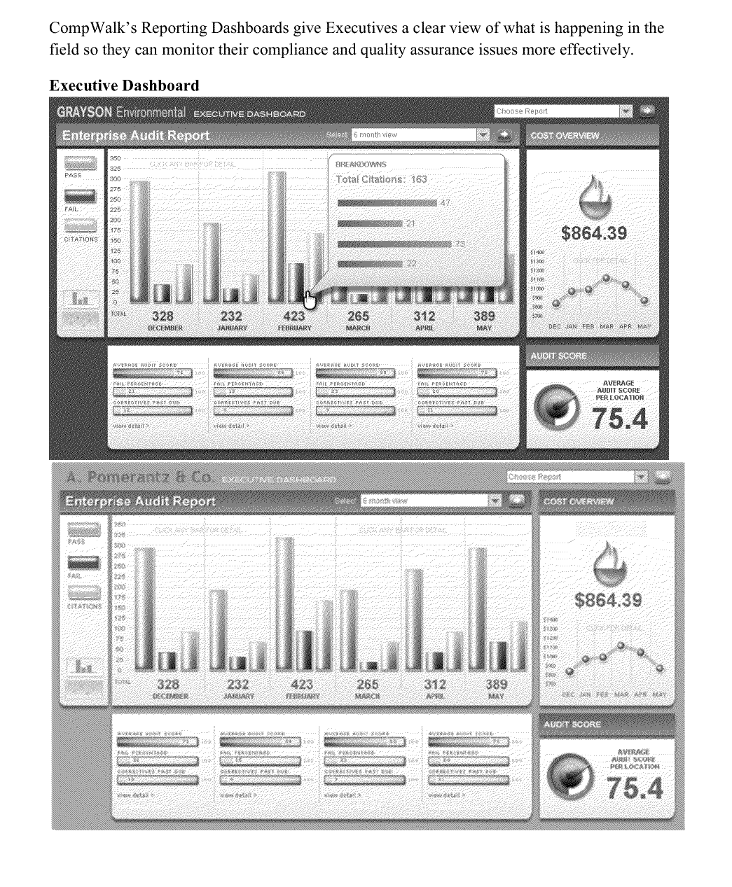

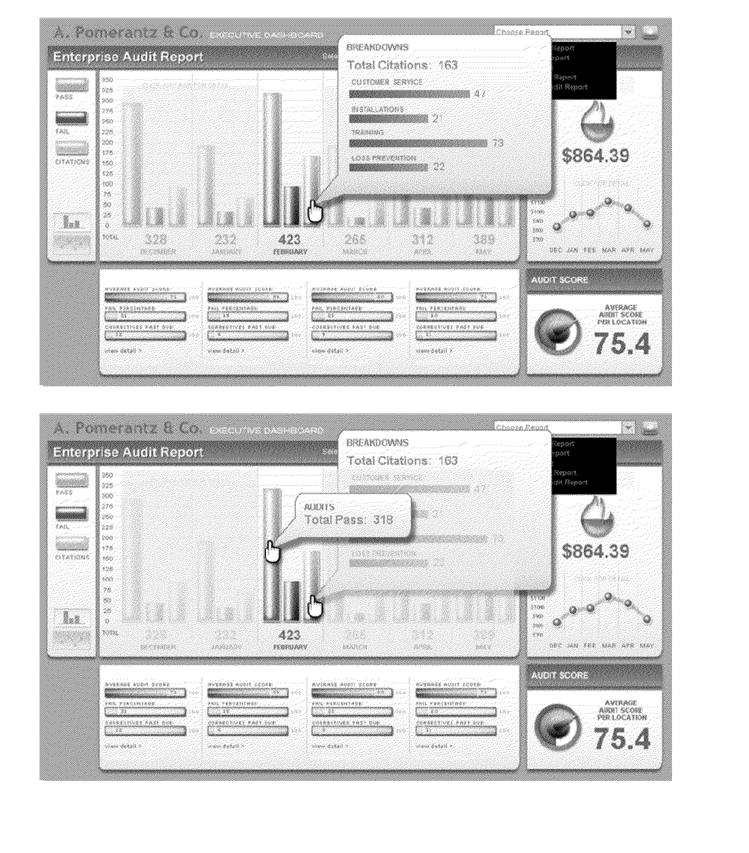

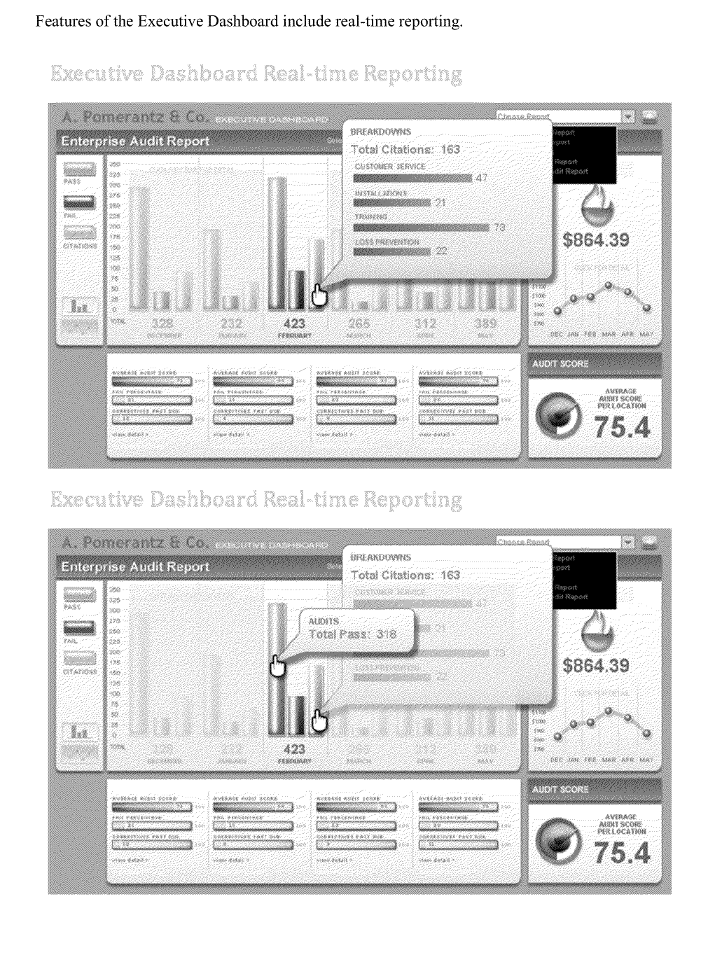

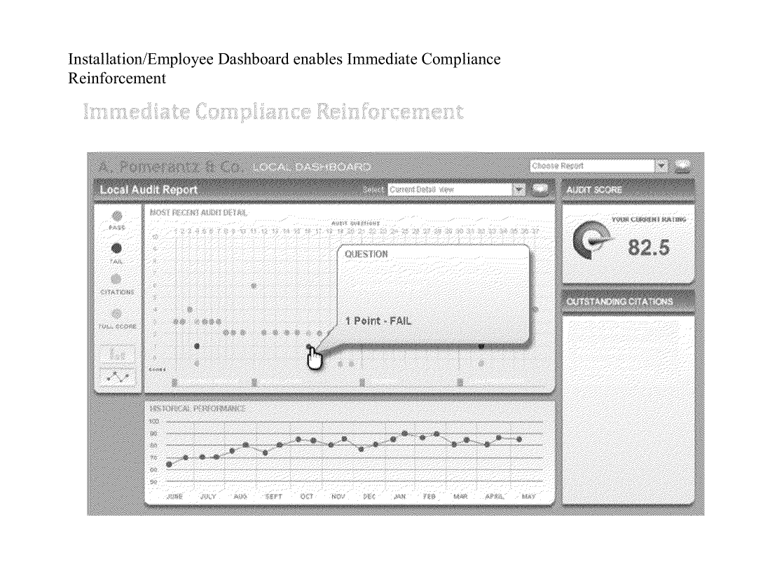

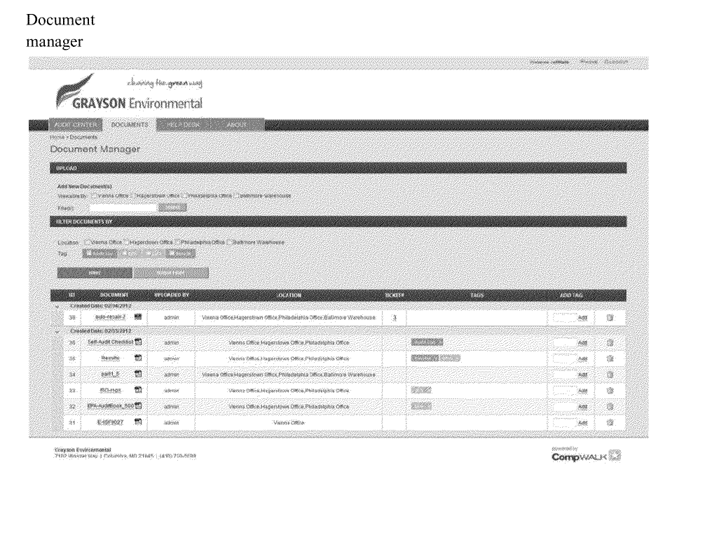

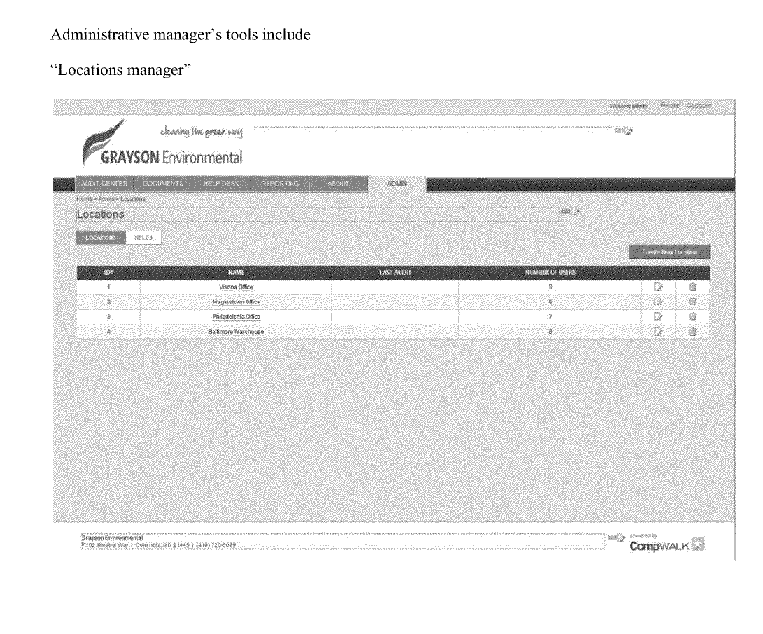

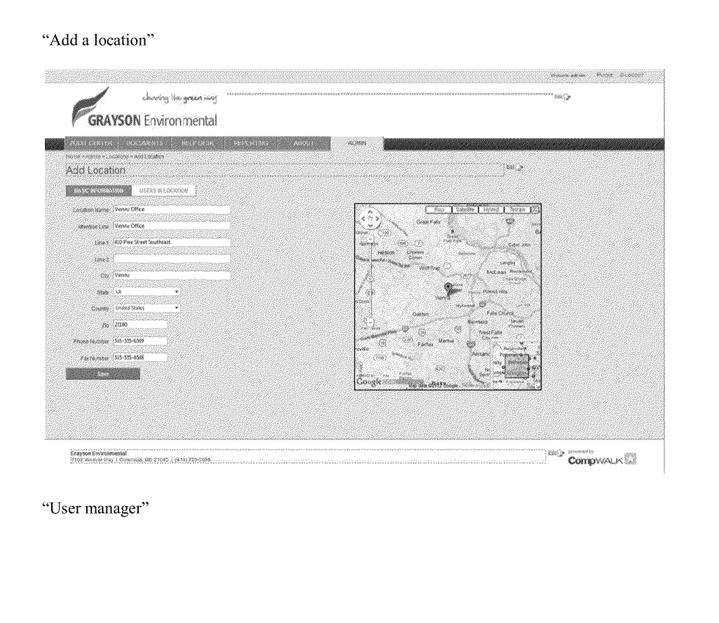

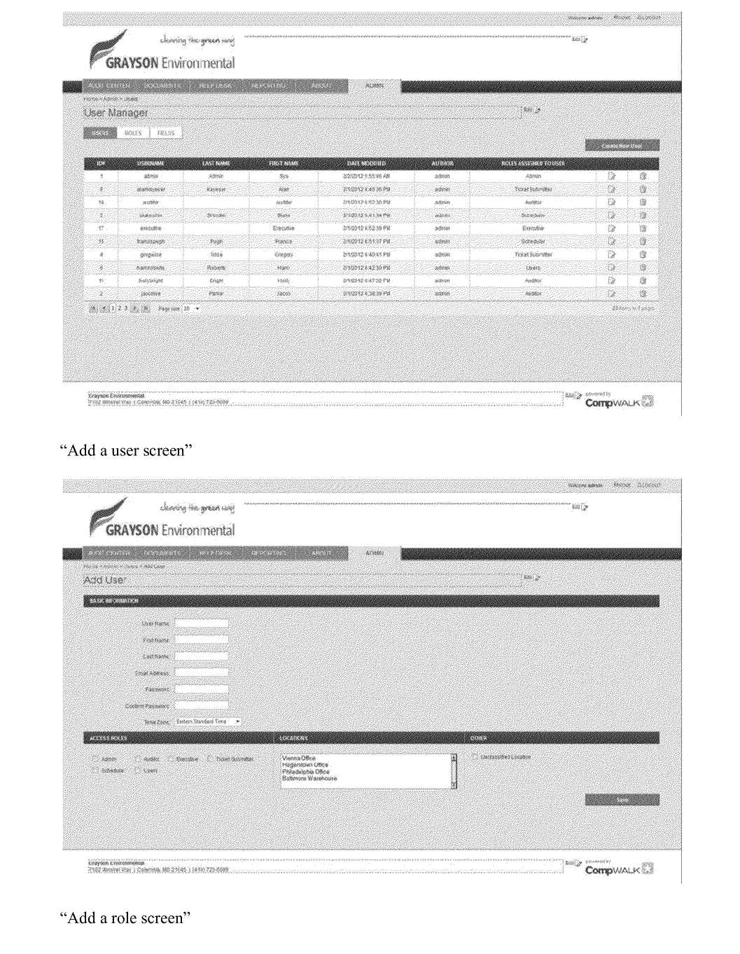

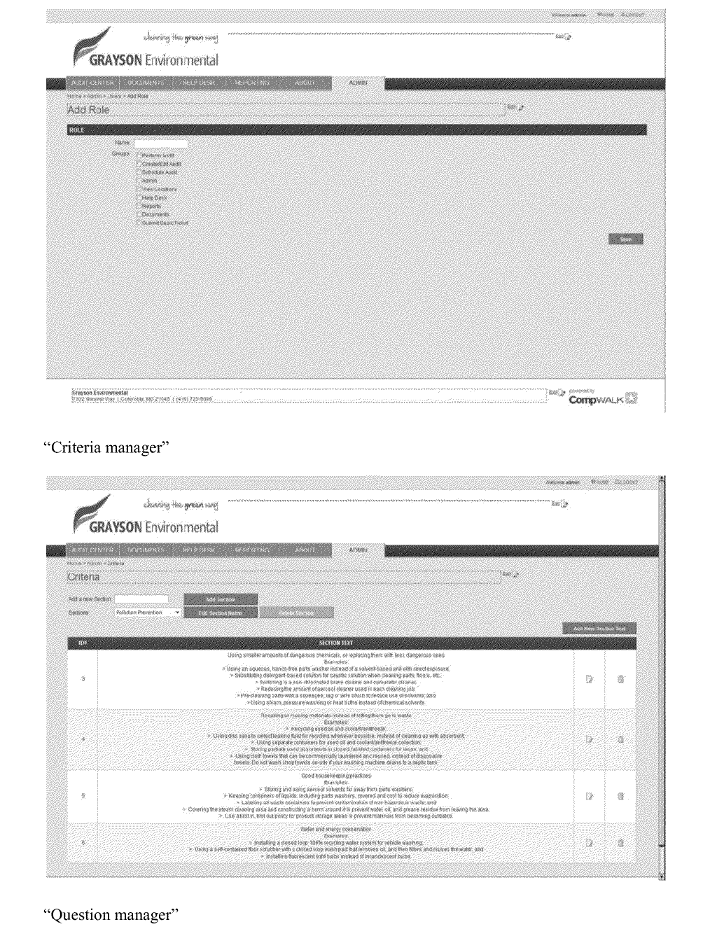

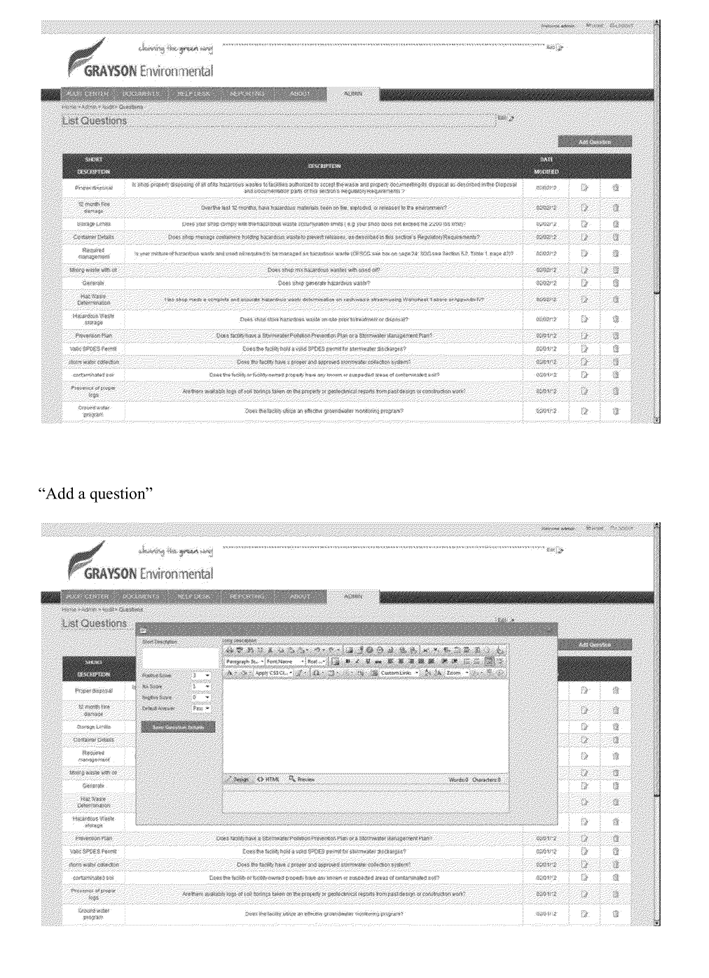

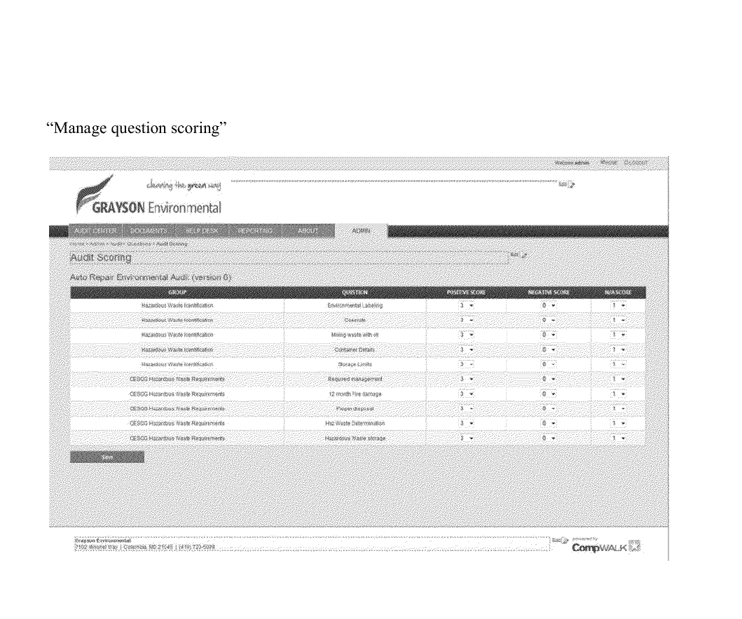

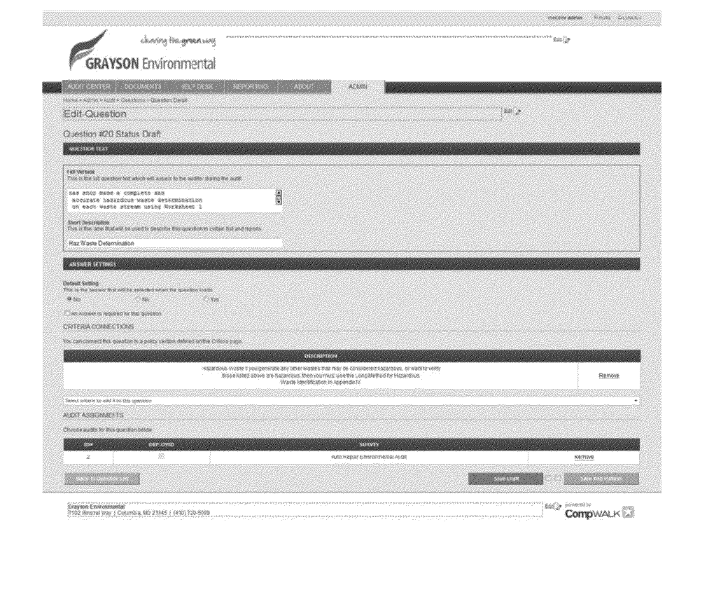

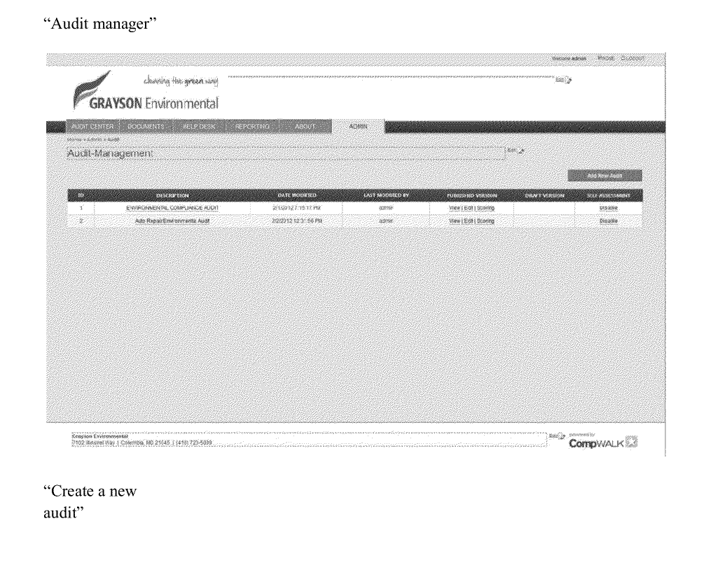

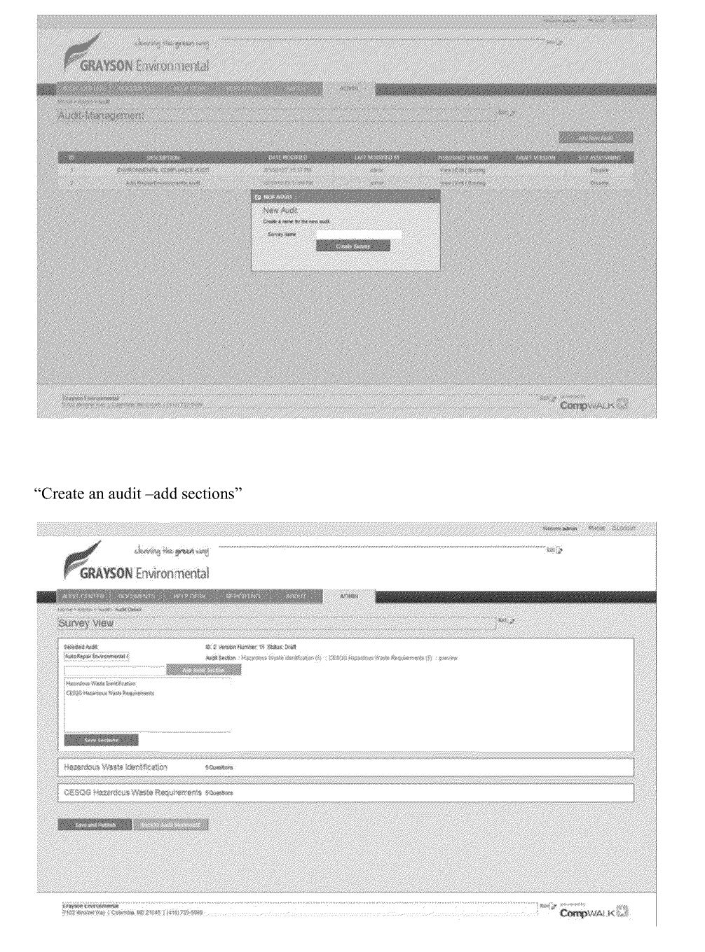

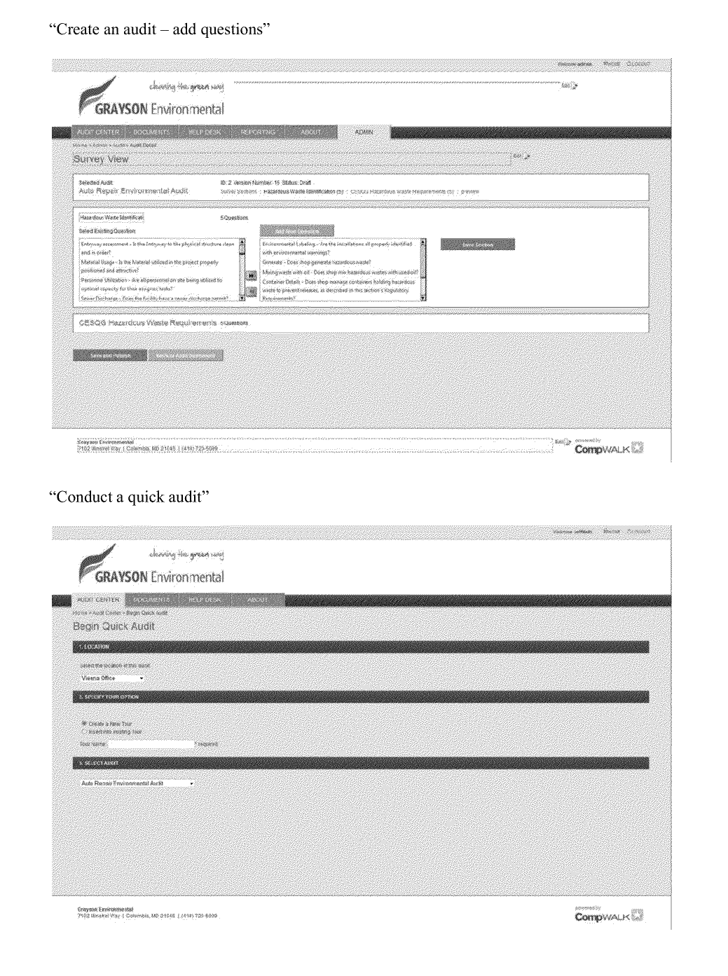

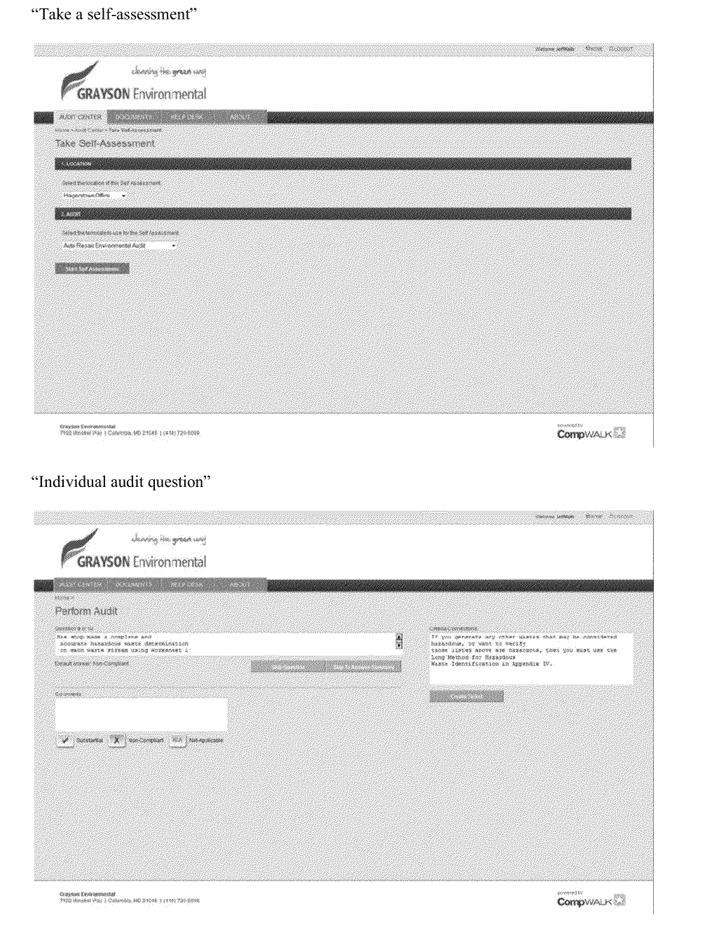

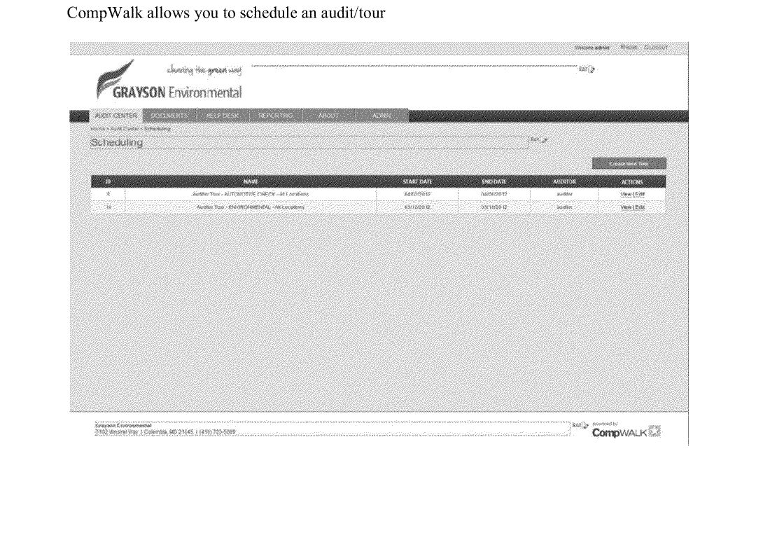

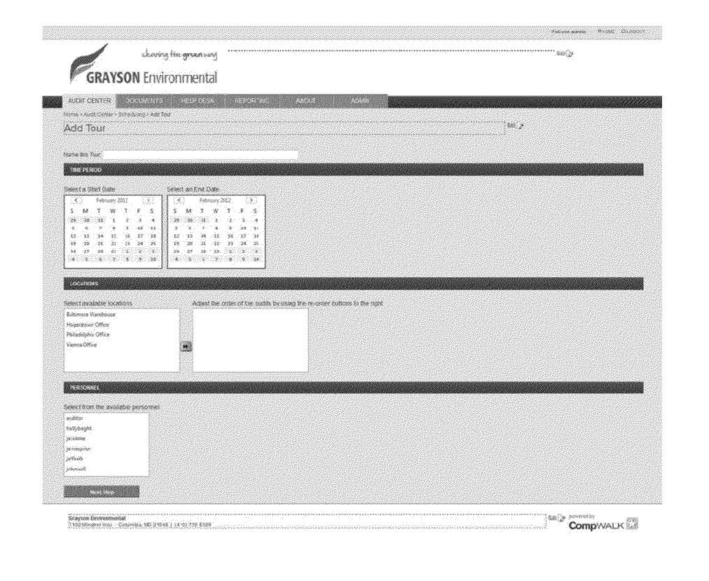

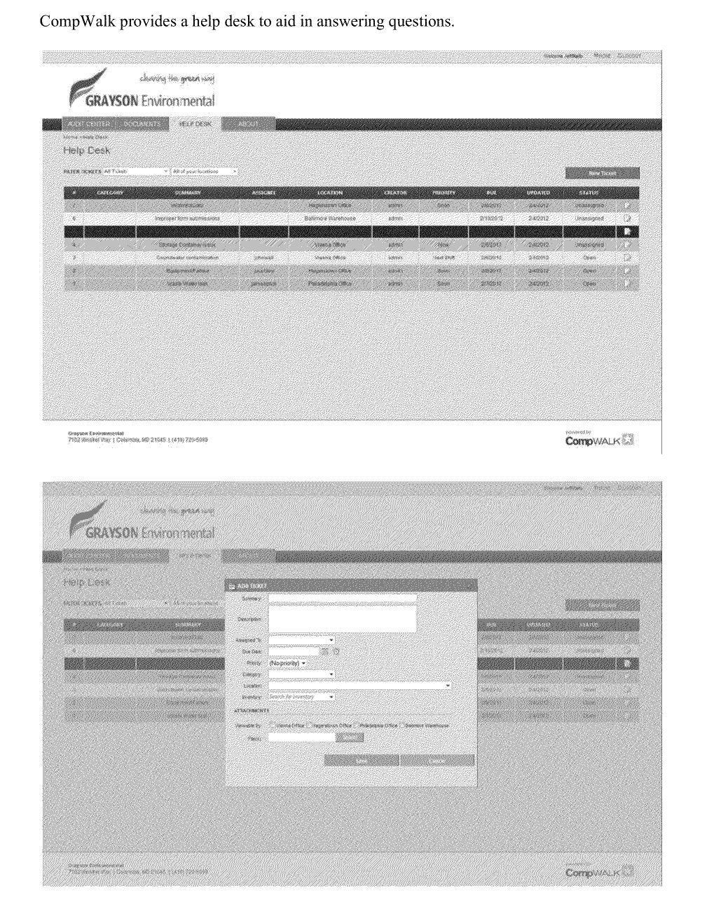

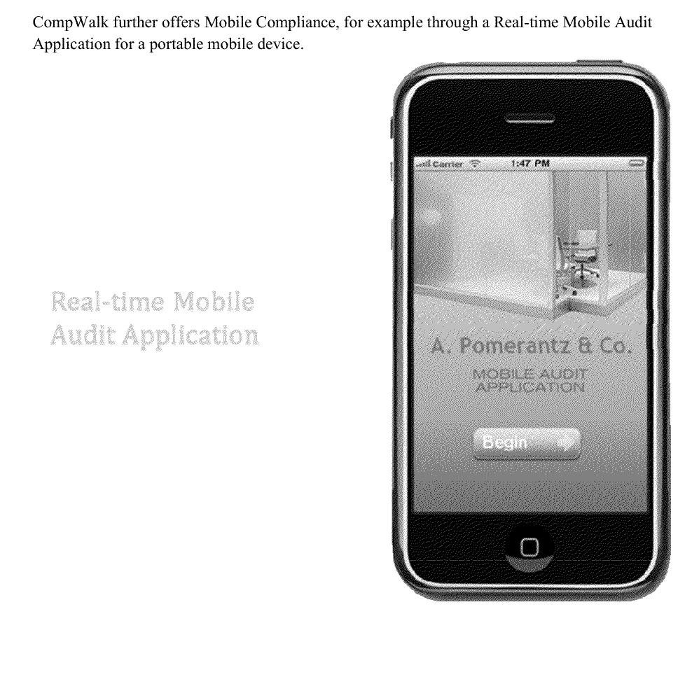

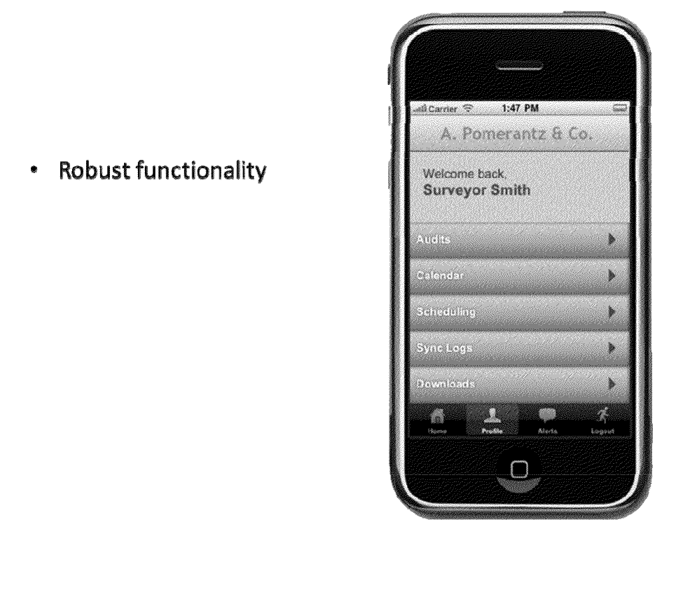

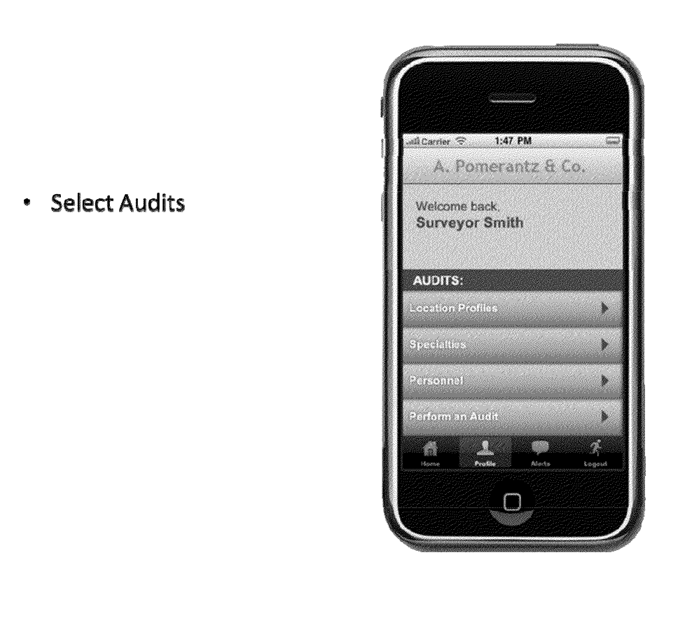

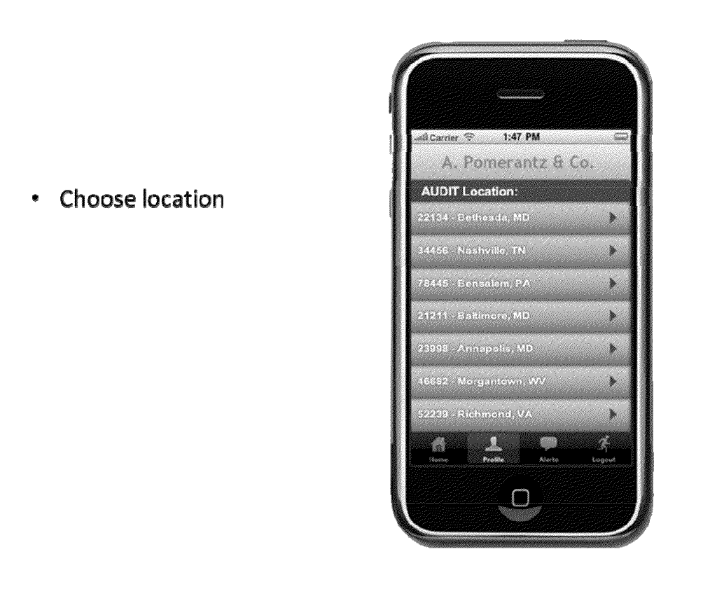

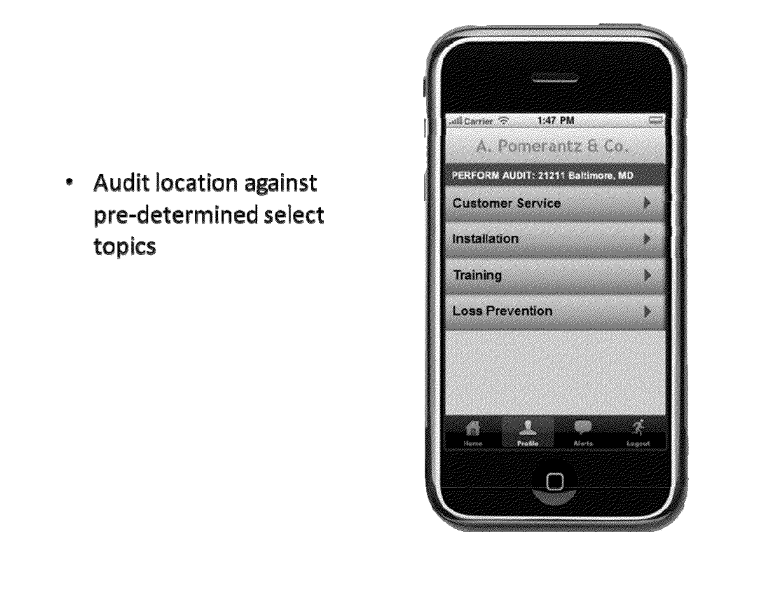

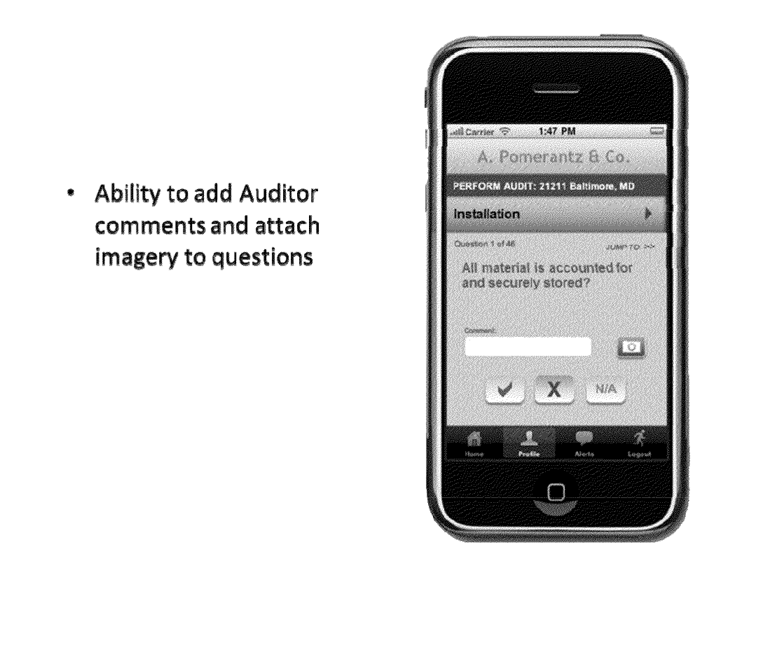

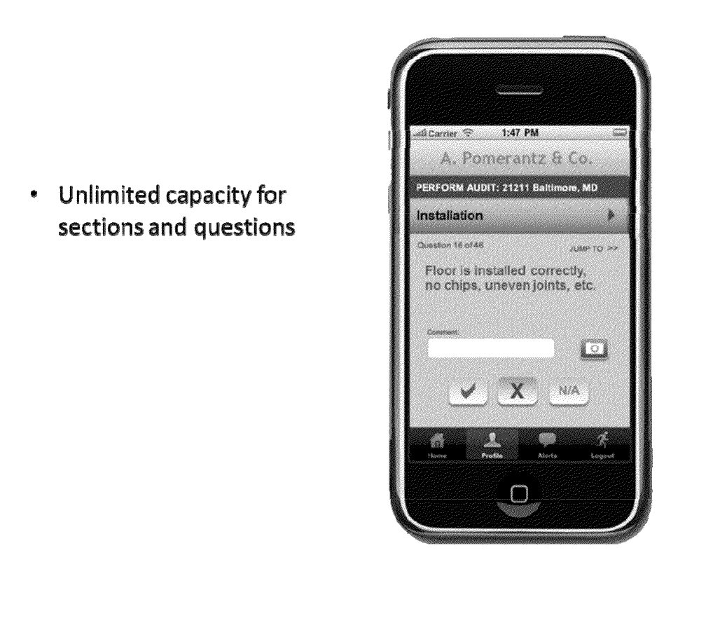

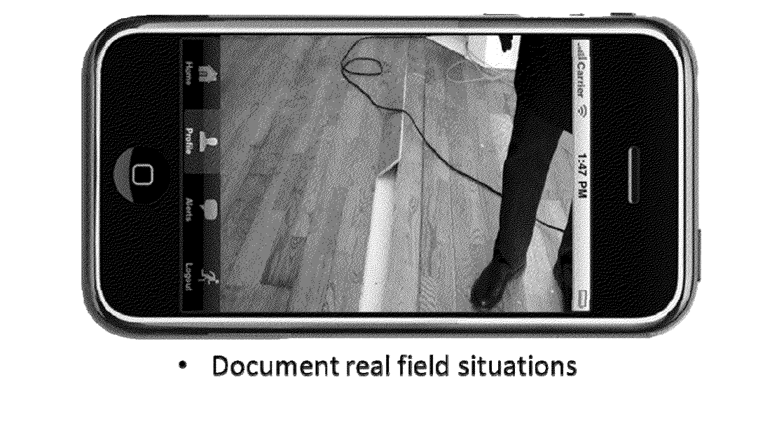

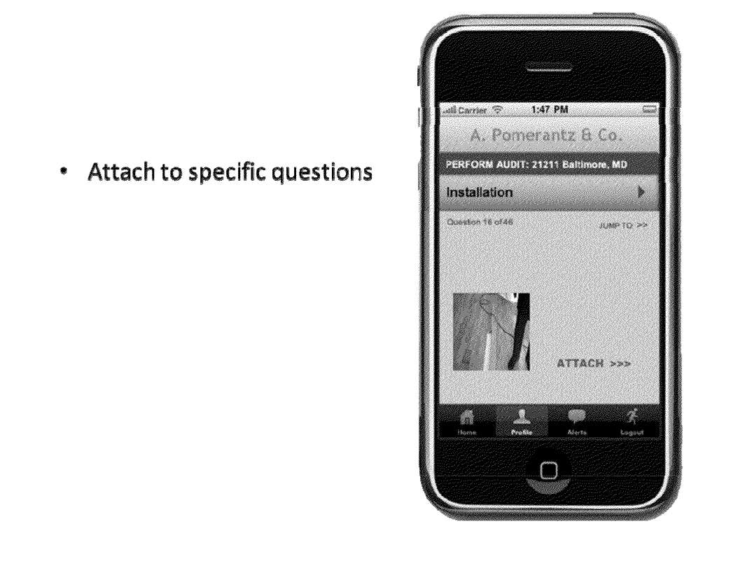

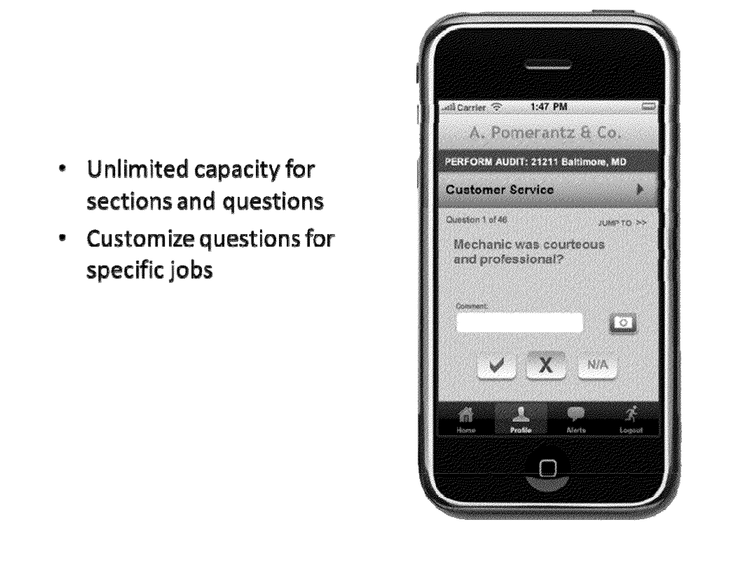

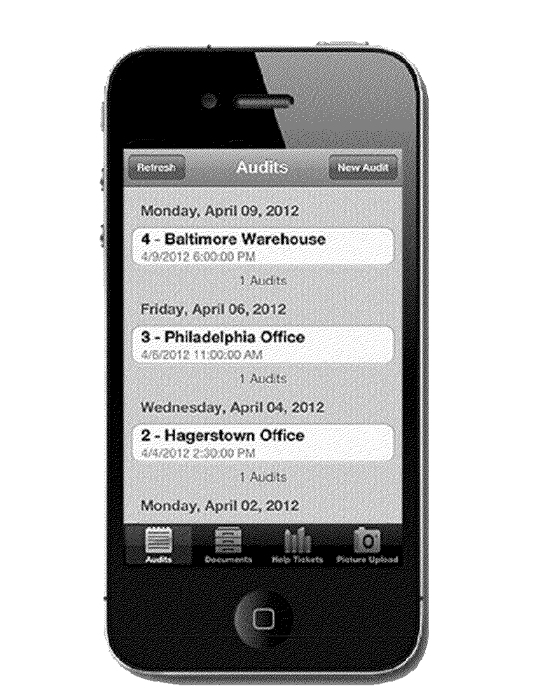

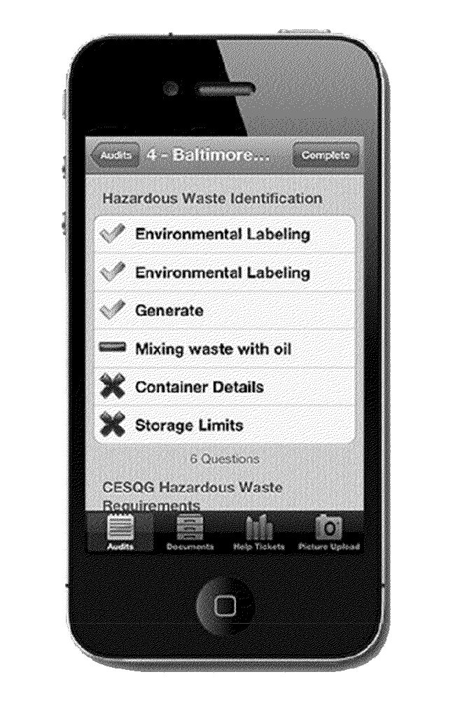

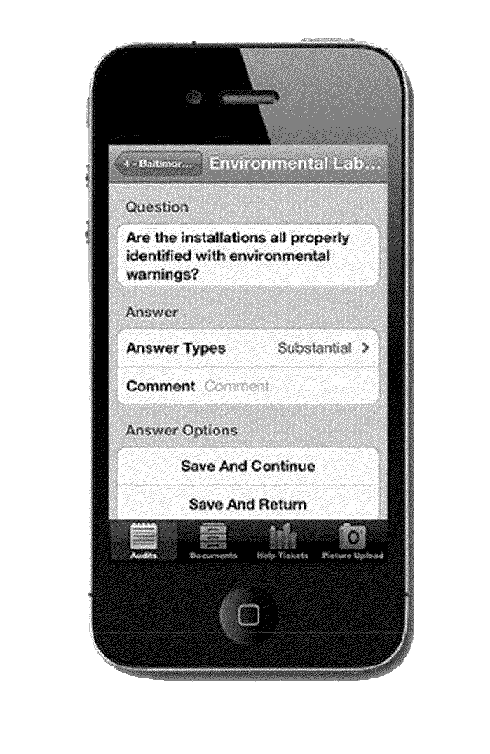

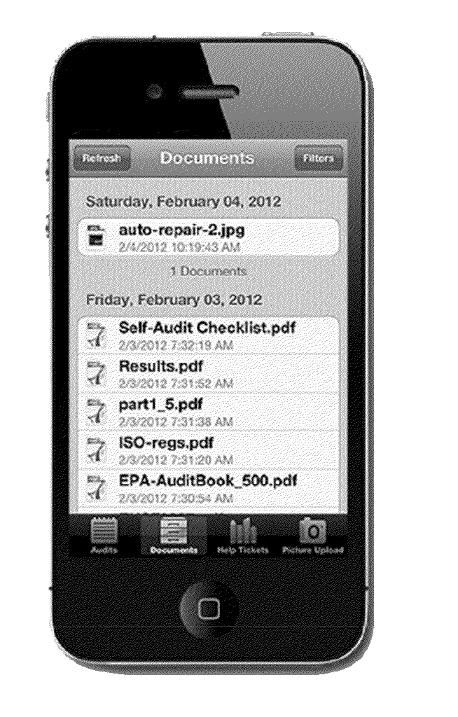

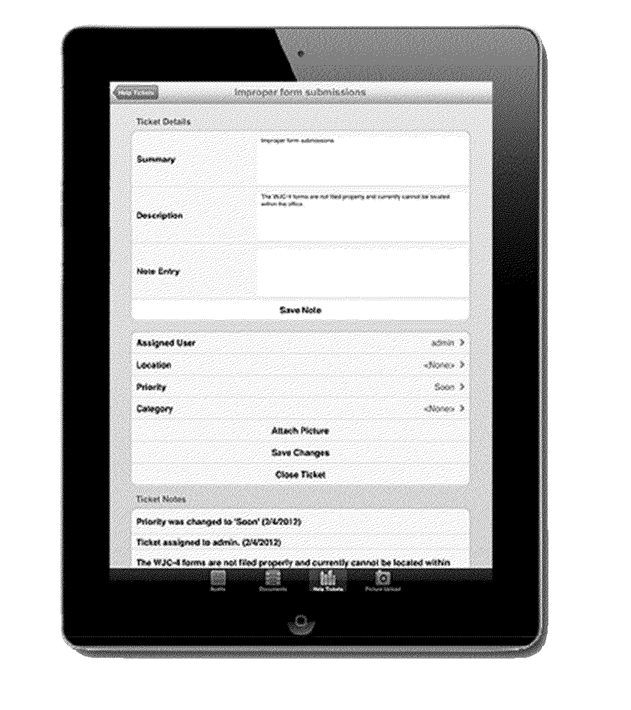

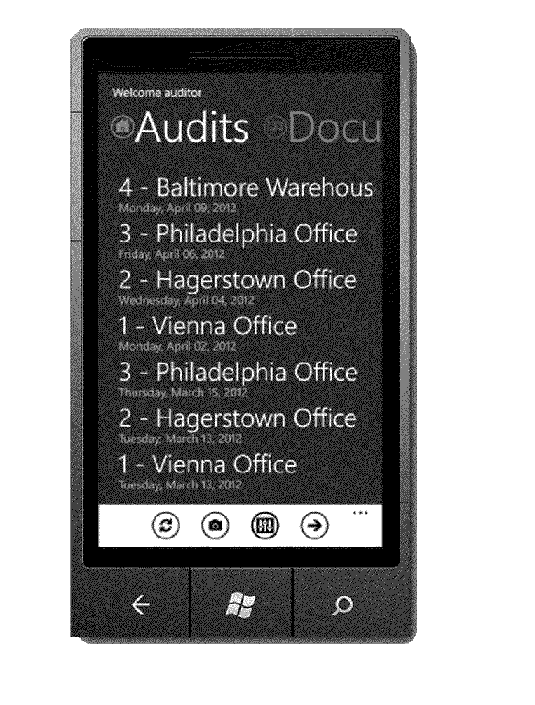

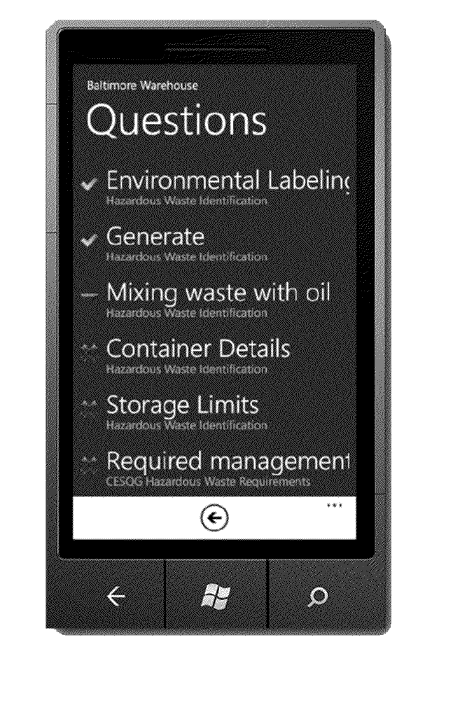

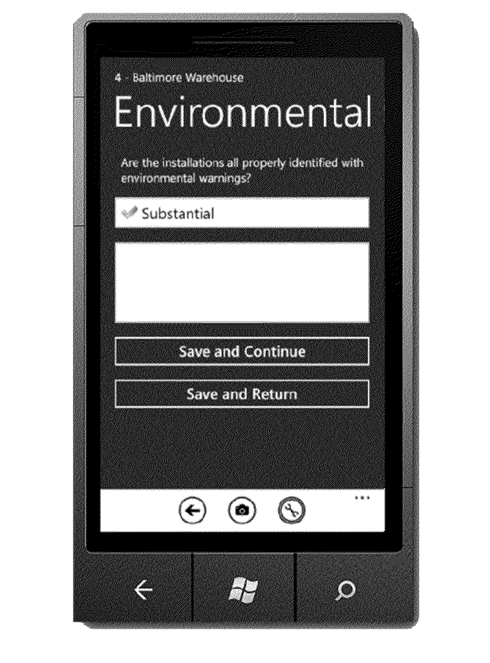

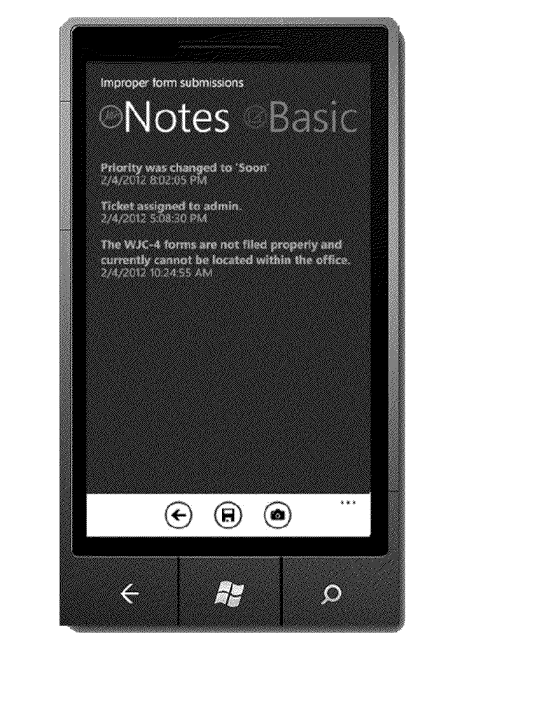

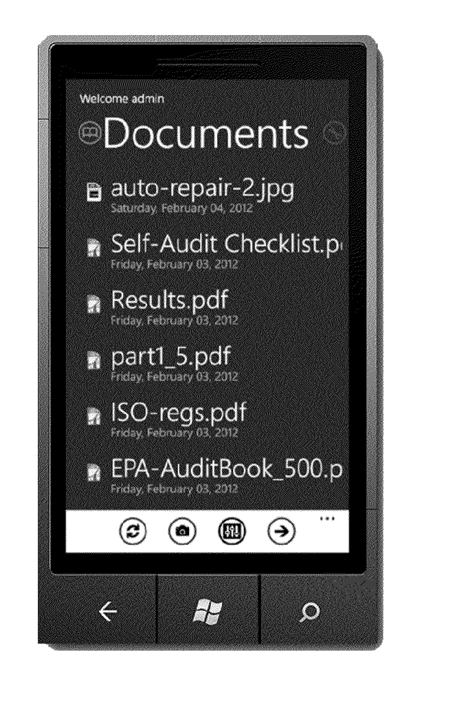

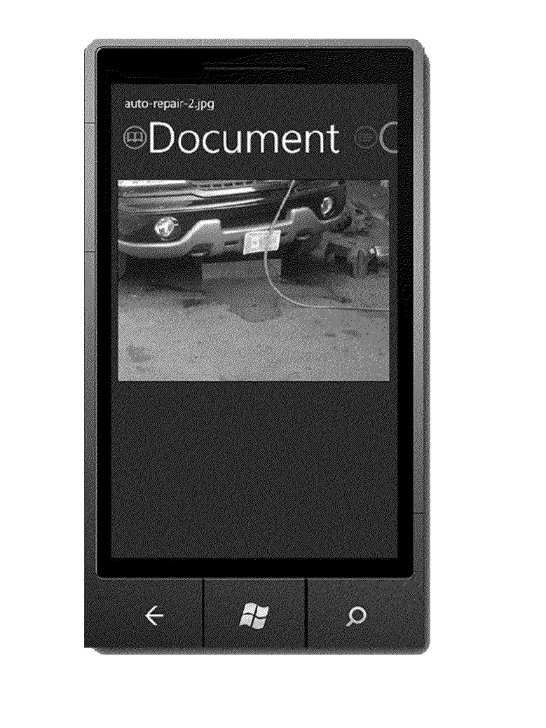

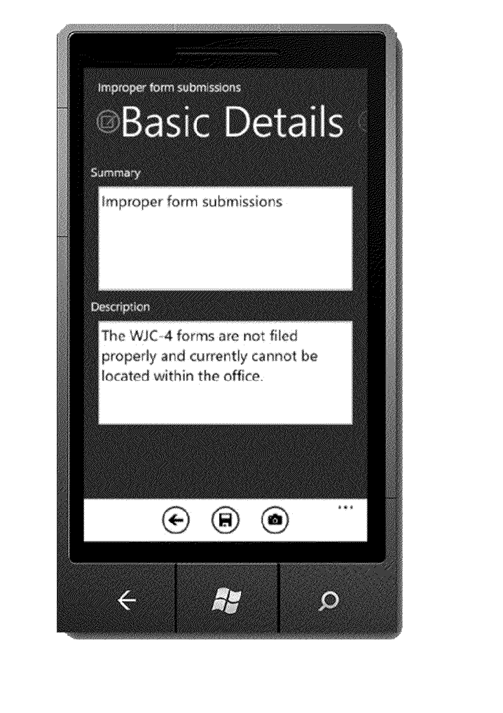

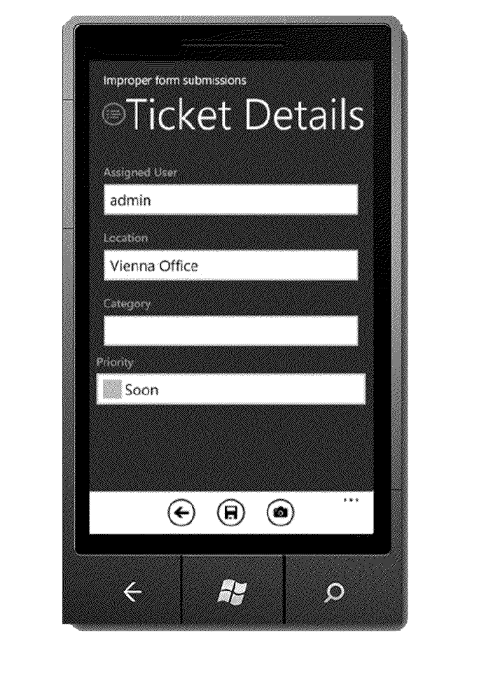

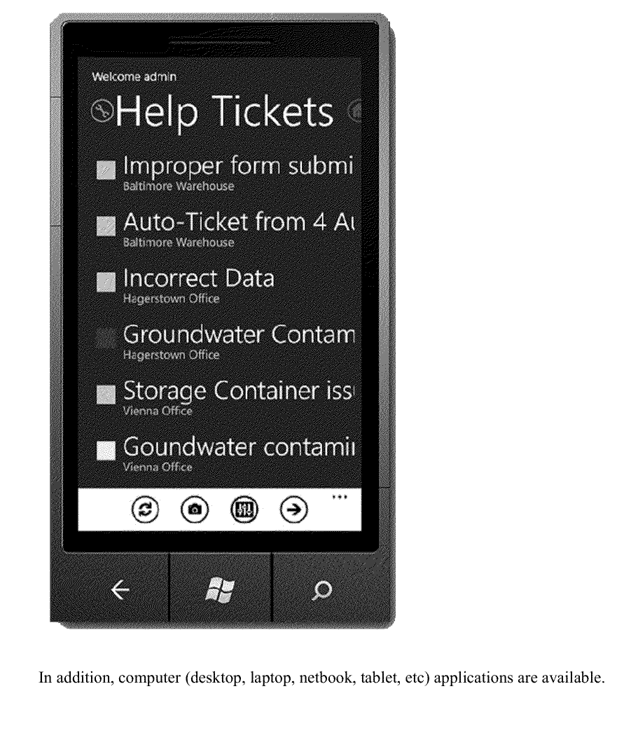

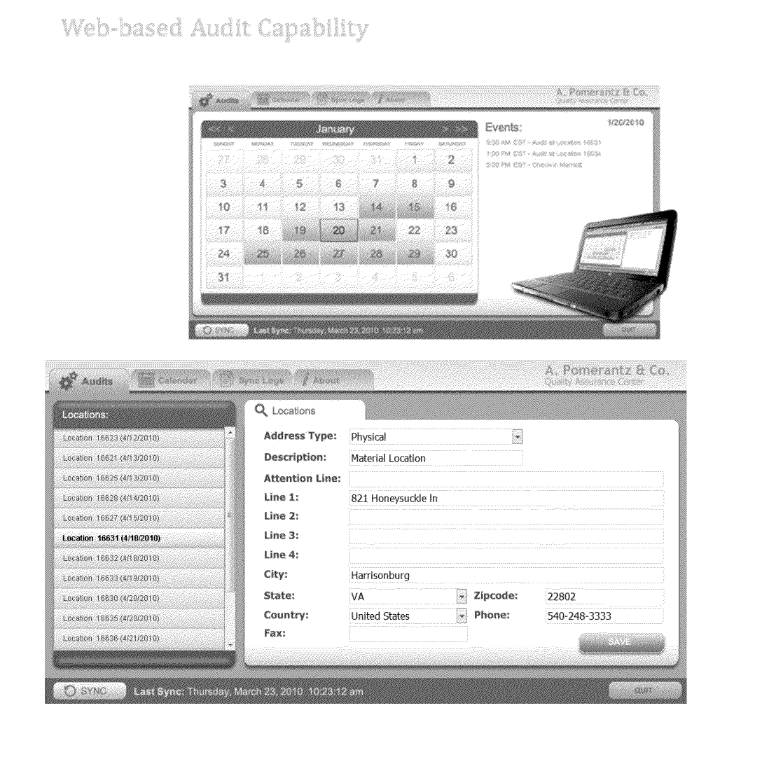

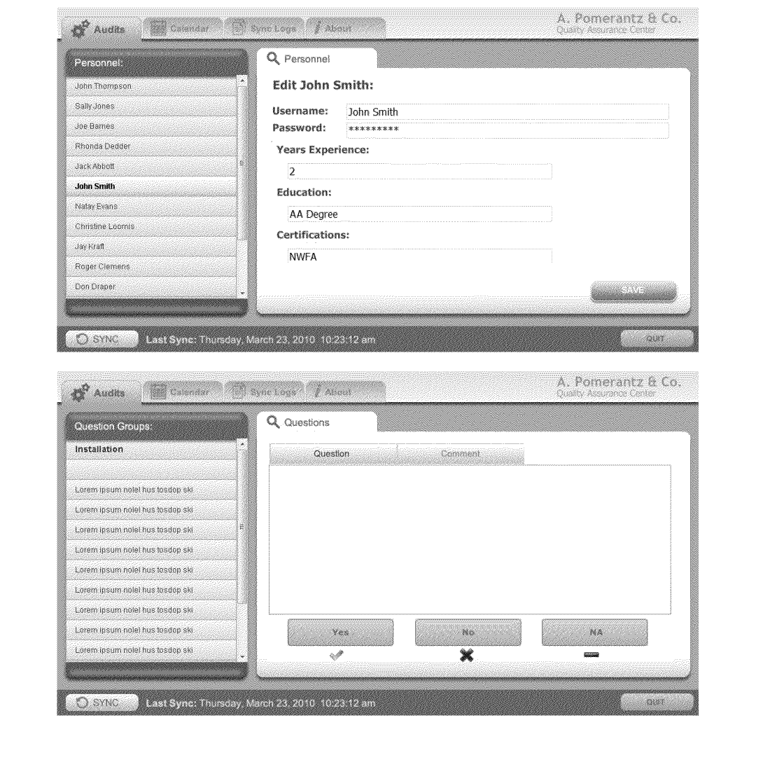

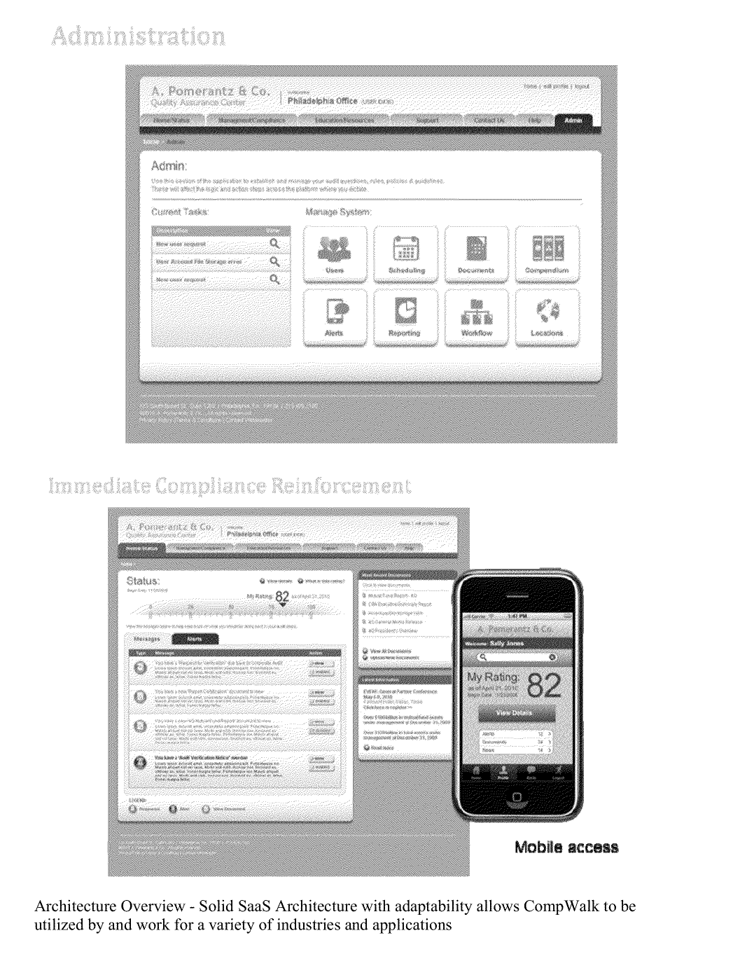

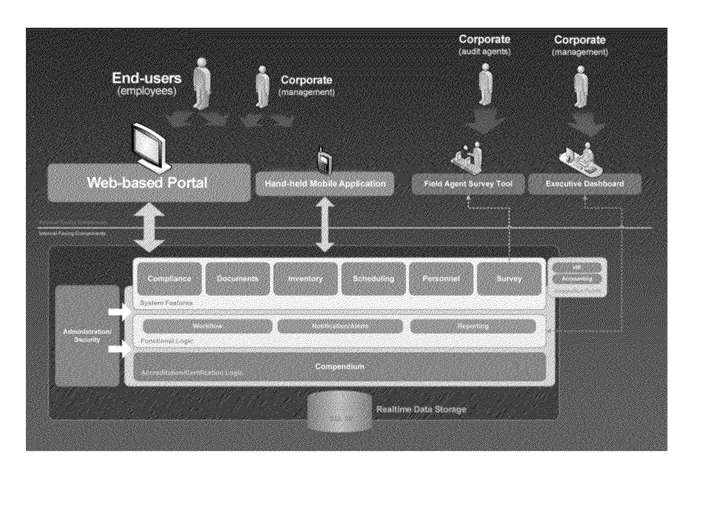

FIG. 5 is a diagram showing the implementation of audit conducting and reporting tools. Since the platform is server based as a Software-as-a-Service (SaaS) model platform, the platform allows for the various end users (i.e. compliance agents, schedulers, business stakeholders, executives, etc.) to utilize a wide array of devices, operating systems. As a SaaS model platform, the system at its core is web-based and delivered through a browser. The type of browser, operating system and device is broad in scope, as defined by conventional web protocols (HTTP, HTTPS, etc.). Using mobile phones, mini and full size tablets as well as laptops and desktop computers, the disclosed technique will work where needed and when needed by users. By way of non-limiting examples, the platform can be implemented through Android, Apple iOS, and WindowsMobile as supported operating systems on the mobile side and for browsers, Chrome, Firefox, Opera, Safari and Internet Explorer. This flexibility and breadth of service allow businesses to expense and inconvenience in implementation of specific platform-specific hardware. In most all cases, existing hardware and software can be leveraged immediately.

### Conclusion

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for auditing, compliance, monitoring and compliance management as shown and described herein.

2. The method of claim 1, further comprising real-time communications.

3. The method of claim 1, further comprising on demand auditing and compliance management.

4. A system for auditing, compliance, monitoring and compliance management as shown and described herein.

5. A computer program product for auditing, compliance, monitoring and compliance management as shown and described herein.

6. A method of providing compliance auditing and management comprising:
defining business or enterprise assets, comprising receiving, from the business or enterprise variables that meet business needs of the business or enterprise as a user;
adding users, locations and audit templates;
entering questions to be provided to the user;
adding compliance criteria used in answering the questions and associating the compliance criteria with the questions;
receiving compliance activity information from the user;
applying the compliance activity information from the user to the questions;
scheduling compliance activity for the user to generate a database of deployed compliance activities;
using the database of deployed compliance activities to conduct compliance activity;
using the database of deployed compliance activities or the conducted compliance activity to generate files and incidents; and
using the database of deployed compliance activities to generate compliance activity reporting.

7. The method of claim 6, further comprising:
scheduling the compliance activity by assigning and deploy the compliance activity immediately to be given or scheduling the compliance activity for a pre-determined time and place;
notifying the user of the deployed or scheduled compliance, thereby permitting the user to review questions, scoring and criteria associated with the compliance activities; and
receiving requests for modifications for supervisory determination of the requests for modifications.

8. The method of claim 6, further comprising:
allowing a compliance agent to initiate an “incident” associated with a specific question or the activity, thereby allowing for predetermined procedure of escalation by the user.
